(19) United States
(12) Patent Application Publication
(10) Pub. No.: US 2026/0370572 A1
(43) Pub. Date: Nov. 19, 2026

(54) METHODS FOR GENERALIZING AI DESIGN IN COMMUNICATION SYSTEMS

(71) Applicant: Telefonaktiebolaget LM Ericsson (publ), Stockholm (SE)

(72) Inventors: Pablo SOLDATI, Solna (SE); Euhanna GHADIMI, Bromma (SE); Burak DEMIREL, Älvsjö (SE)

(73) Assignee: Telefonaktiebolaget LM Ericsson (publ), Stockholm (SE)

(21) Appl. No.: 19/478,133

(22) PCT Filed: May 3, 2024
(86) PCT No.: PCT/EP2024/062273

§ 371 Date: Oct. 23, 2025

Related U.S. Application Data
(60) Provisional application No. 63/464,351, filed on May 5, 2023.

(51) Int. Cl. H04L 41/16; H04B 17/318

(52) U.S. Cl. CPC H04L 41/16; H04B 17/318

(57) ABSTRACT

A computer-implemented method, executed by a first network node in a communication network environment, for generalizing design of at least one artificial intelligence/machine learning (AI/ML) model for configuring at least one network functionality in the environment is provided. The method includes obtaining a first set of network state information for reconstructing the environment to configure the at least one network functionality. The method includes determining, based on a first AI/ML model, an encoding reconstructing the environment where the at least one network functionality to be configured is operating, wherein input to the first AI/ML model includes the first set of network state information. The method includes executing the first AI/ML model, wherein the output of executing the first AI/ML model includes the encoding reconstructing the environment. The method includes obtaining a second set of network state information for reconstructing the environment to configure the at least one network functionality. The method includes determining information for configuring the at least one network functionality based on one or more of: (i) the encoding reconstructing the environment where the at least one network functionality to be configured is operating, (ii) the second set of network state information for environment reconstruction, and/or (iii) a representation of at least one metric associated with the at least one network functionality to be optimized. The method includes configuring, based on the information, the at least one network functionality.

### TECHNICAL FIELD

Disclosed are embodiments related to methods for generalizing artificial intelligence/machine learning (AI/ML) design in communication systems.

### BACKGROUND

### Overall Architecture of NG-RAN

FIG. 1 illustrates the current 5G RAN (a.k.a., the Next Generation RAN (NG-RAN)) architecture. The NG-RAN architecture 100 is described in 3GPP Technical Specification (TS) 38.401 v 17.0.0 (“TS 38.401”). The NG-RAN consists of a set of base stations 102 (denoted “gNBs”) connected to a 5G core network 104 (5GC) through an NG interface 106. The gNBs 102 can be interconnected through an Xn interface, which is an interface used for communications between two NG-RAN nodes.

As specified in 3GPP TS 38.300 v 17.1.0 (“TS 38.300”), a gNB 102 may consist of a gNB central unit 108 (gNB-CU) and one or more gNB distributed units 110 (gNB-DU(s). A gNB-CU 108 and a gNB-DU 110 are connected via an F1 interface 112. One gNB-DU is connected to only one gNB-CU. The NG, Xn and F1 interfaces are logical interfaces. A gNB-CU may comprise a gNB-CU control plane (CP) function (gNB-CU-CP) and a gNB-CU user plane (UP) function (gNB-CU-UP).

As specified in 3GPP TS 38.300, NG-RAN could also consist of a set of ng-eNBs, an ng-eNB may consist of an ng-eNB-CU and one or more ng-eNB-DU(s). An ng-eNB-CU and an ng-eNB-DU is connected via W1 interface. The general principle described in this section also applies to ng-eNB and W1 interface, if not explicitly specified otherwise.

A gNB can support FDD mode, TDD mode or dual mode operation.

gNBs can be interconnected through the Xn interface.

As illustrated in FIG. 2, a gNB 202 may consist of a gNB-CU 220 and one or more gNB-DU(s) 210. A gNB-CU 220 and a gNB-DU 210 are connected via F1 interface 240.

One gNB-DU is connected to only one gNB-CU.

NG, Xn and F1 are logical interfaces.

For NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

FIG. 2 illustrates the overall architecture for separation of gNB-CU-CP and gNB-CU-UP.

Artificial Narrow Intelligence (ANI) and Artificial General Intelligence (AGI) Artificial intelligence (AI) can broadly be classified into artificial narrow intelligence (ANI) and artificial general intelligence (AGI). The former, ANI, refers to a task-oriented Al design aimed to excel in a particular domain, such as object recognition, playing a specific game, etc. The latter, AGI, refers to algorithms that can learn and carry out any (or a large range of) intelligent task, as well as or better than human beings. Today's applications of Al to communication systems are typically ANI—that is, designed and trained to address a specific networking task, such as encoding-decoding information at the physical layer, resource allocation (e.g., power control, scheduling, etc.) at the MAC layer, etc.

Achieving generalization is a fundamental design principle for both AGI and ANI. For narrow AI, generalization can be defined within the context of the task to be solved as the ability to cope with new conditions not directly observed during training, yet inferable from the distribution of the training data. For example, a self-driving car should recognize pedestrians crossing the road regardless of whether it is in proximity of a pedestrian crossing sign or observing an illegal jaywalking. Another aspect of generalization is the ability to learn an unbiased model, that is, a model that does not work better or favors certain conditions over others.

Different types of AI algorithms, herein also referred to as AI processes, may require or offer different means to generalize. For machine learning (ML) algorithms, such as supervised learning (SL) or unsupervised learning (USL), generalization has been improved by augmenting the training dataset. For object recognition applications, for instance, where collecting a large training set of labelled pictures could be costly, data could be augmented by means of rotations, translation, and cropping. More recently, however, quantum leaps in the ability to generalize have been achieved by algorithmic breakthroughs as well as the wider and more affordable availability of powerful computing and storage capacity. Object recognition ANI algorithms, for instance, have greatly improved by the ability to train more sophisticated convolutional neural networks (CNN) with more advanced optimizers. ANI for neural language process applications, on the other hand, have capitalized by the introduction of recurrent neural networks (RNN) first, and more recently by the introduction of transformers, which demonstrated the importance of an attention layer in AI, and its later evolution into graph attention networks (GAT). These techniques, together with the availability of an extremely large dataset (the Internet itself) are at the core of one of the most general ANI application, ChatGPT.

There currently exist certain challenge(s). Over the past few years, a large body of academic and industrial research has successfully demonstrated the potential of Al to automate and improve performance of many design aspects of communication networks, ranging from physical layer (L1) applications to radio resource management (in L2-L3) and network optimization and configuration. The majority of Al research in this field has focused on artificial narrow intelligence (ANI), that is, on task-oriented Al designed to solve a specific problem. While ANI is a natural choice for introducing Al technology in communication networks, the Al design is often tailored to and evaluated for narrow network conditions. We refer to this as specialized ANI.

While this approach offers simple design and reasonable computational complexity, it raises several challenges in replacing RAN algorithms with Al, including the ability to generalize and thereby cope with new situations.

Specialized ANI solutions pose several concerns. Firstly, creating a unique AI model for each RAN feature (e.g., link adaptation) to suit specific conditions and environments (e.g., a particular radio cell) necessitates training and managing possibly thousands of models. This could be expensive and impractical, even with a fully reliable and automated system. Secondly, specialized ANI solutions may lack robustness since they could be biased towards the (limited) conditions observed during training, making them incapable of handling diverse RAN deployments and radio environment dynamics. As a result, regular updates may be necessary for model lifecycle management.

Furthermore, focusing on ANI solutions for specific tasks may result in multiple AI-powered RAN features that operate independently and concurrently at the same timescale (i.e., within the same protocol layer) and learn from the same environment (e.g., the same cells). This coexistence can make the learning process challenging and unstable.

Prior-art solutions for AI in communication networks do not provide efficient ways to address generalization of the AI model design for applications to communication systems.

### SUMMARY

It is an object of the present disclosure to provide methods for generalizing artificial intelligence/machine learning (AI/ML) design in communication systems.

Certain aspects of the present disclosure and the embodiments disclosed herein provide solutions to these and other challenges.

To ensure sustainable, scalable, and efficient integration of Al technology into RAN systems, it is crucial to prioritize Al model generalization, even within the context of task-oriented solutions. In this regard, three generalization domains are identified for Al applications in communication networks-namely, the network environment (e.g., deployment and configuration, the network control tasks (e.g., specific to one or more network functionalities), and the network intents/KPIs/objectives. Embodiments disclosed herein provide methods to generalize the design of Al models and algorithms for applications in communication systems, wherein the generalization of an Al algorithm design is achieved over one or more of:
the communication system environment or deployment;
one or more intents, KPIs or objectives driving the operations of the communication system or an application thereof; and
one or more functionalities of the communication system, or the related control parameters.

According to a first aspect of the present disclosure, a computer-implemented method, executed by a first network node in a communication network environment, for generalizing design of at least one artificial intelligence/machine learning (AI/ML) model for configuring at least one network functionality in the environment is provided. The method includes obtaining a first set of network state information for reconstructing the environment to configure the at least one network functionality. The method further includes determining, based on a first AI/ML model, an encoding reconstructing the environment where the at least one network functionality to be configured is operating, wherein input to the first AI/ML model includes the first set of network state information. The method further includes executing the first AI/ML model, wherein the output of executing the first AI/ML model includes the encoding reconstructing the environment. The method further includes obtaining a second set of network state information for reconstructing the environment to configure the at least one network functionality. The method further includes determining information for configuring the at least one network functionality based on one or more of: (i) the encoding reconstructing the environment where the at least one network functionality to be configured is operating; (ii) the second set of network state information for environment reconstruction; and/or (iii) a representation of at least one metric associated with the at least one network functionality to be optimized. The method further includes configuring, based on the information, the at least one network functionality.

In an exemplary embodiment, configuring, based on the information, the at least one network functionality, includes sending the information.

In an exemplary embodiment, the information for configuring the at least one network functionality includes one or more of parameters and/or instructions.

In an exemplary embodiment, the first set of network state information includes static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells.

In an exemplary embodiment, determining information for configuring the at least one network functionality is further based on a second AI/ML model, wherein input to the second AI/ML model includes one or more of: the encoding reconstructing the environment where the at least one network functionality to be configured is operating; the second set of network state information for environment reconstruction; and/or a representation of at least one metric associated with the at least one network functionality to be optimized; and the method further comprises executing the second AI/ML model, wherein the output of executing the second AI/ML model includes the information for configuring the at least one network functionality.

In an exemplary embodiment, the second set of network state information includes dynamically changing information characterizing one or more of: a state associated to the network functionality to be configured; information associated to a state of network nodes, radio cells or user devices involved with the network functionality; measurements or predictions of signal strength or signal quality; measurements or predictions or cell load information and/or cell capacity information; measurements or predictions of energy consumption or an energy saving mode for user devices, radio cells or network nodes; observable dynamics of the at least one network functionality to be configured, information associated to the state of the first network node, and/or to the state of at least a second network node, and/or to the state of at least a user device; information associated to the state dynamics of at least a functionality a network node or a radio cell; and/or information associated to the state dynamics of at least a functionality a user device.

In an exemplary embodiment, the first AI/ML model is designed such that the encoding reconstructing the network environment is associated to one of the first network node, a serving cell of the first network node, or a user device served by at least a serving cell of the first network node.

In an exemplary embodiment, the at least one network functionality includes one or more of: network functionalities operating at different levels of the RAN protocol stack including from physical layer (PHY) to medium access control (MAC) layer, routing, transport, application layer, network configuration and deployment and core network operations; PHY layer functionalities, channel estimation, signal demodulation, and decoding; MAC layer functionalities, link adaptation, radio resource allocation, user scheduling over time and frequency resources, power control, and precoding; and/or functionalities acting on network configuration, mobility optimization, mobility load balancing, capacity and coverage optimization, energy saving configurations, cell shaping, network hyperparameters configuration, antenna tilt, control channel resources, semi-static uplink power control parameters, TTD configuration, FDD configuration, discontinuous transmission DTX configuration, discontinuous reception DRX configurations, configuration of downlink reference signals, and network slicing such as configuration of network slices and allocation of radio resources to network slices or subscribers thereof.

In an exemplary embodiment, the first set of network state information and/or the encoding reconstructing the environment includes one of: network-node-centric state information and/or environment reconstruction; cell-centric state information and/or environment reconstruction; or user-centric state information and/or environment reconstruction.

In an exemplary embodiment, the first set of network state information is represented in the form of a graph constructed as one of: a network-centric graph, a cell-centric graph, or a user-centric graph.

In an exemplary embodiment, the communication network environment includes one or more of: a radio access network (RAN) environment and/or an open radio access network (O-RAN) environment.

In an exemplary embodiment, the first network node is one of: a RAN node, an OAM, a Core Network node, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, or a UE.

In an exemplary embodiment, the first network node is configured as one of: a physical node, a function, or a logical entity.

In an exemplary embodiment, the first network node is configured as a logical entity and the logical entity is: configured as a software entity; implemented in one of a data center or a cloud; or implemented using one or more virtual machines.

In an exemplary embodiment, the method further comprises receiving, at the first network node, information characterizing a set of network nodes and/or radio cells surrounding a reference network node or radio cell that are related to and/or have an effect on the performance of the reference network node or radio cell.

In an exemplary embodiment, the representation of at least one metric associated with the at least one network functionality to be configured includes at least one metric associated to one of: a user device, a radio cell, or at least a network node.

In an exemplary embodiment, the at least one metric includes one or more of: an intent, objective, and/or key performance indicator (KPI).

According to a second aspect of the present disclosure, a computer-implemented method, a computer-implemented method, executed by a first network node in a communication network environment, for generalizing design of at least one artificial intelligence/machine learning (AI/ML) model for configuring at least one network functionality in the environment is provided. The method includes obtaining a first set of network state information for reconstructing the environment to configure the at least one network functionality. The method also includes determining, based on a first AI/ML model, an encoding reconstructing the environment where the at least one network functionality to be configured is operating, wherein input to the first AI/ML model includes the first set of network state information. The method further includes executing the first AI/ML model, wherein the output of executing the first AI/ML model includes the encoding reconstructing the environment. The method also includes obtaining a second set of network state information for reconstructing the environment to configure the at least one network functionality. The method also includes determining information for configuring the at least one network functionality based on one or more of: (i) the encoding reconstructing the environment where the at least one network functionality to be configured is operating; (ii) first set of network state information for environment reconstruction; (iii) the second set of network state information for environment reconstruction; and/or (iv) a representation of at least one metric associated with the at least one network functionality to be optimized. The method further includes configuring, based on the information, the at least one network functionality.

According to a third aspect of the present disclosure, a computer-implemented method, executed by a first network node in a communication network environment, for generalizing design of at least one artificial intelligence/machine learning (AI/ML) model for configuring at least one network functionality in the environment is provided. The method includes obtaining a first set of network state information for reconstructing the environment to configure the at least one network functionality. The method also includes obtaining a second set of network state information for reconstructing the environment to configure the at least one network functionality. The method also includes executing a third AI/ML model, wherein input to the third AI/ML model includes one or more of: (i) the first set of network state information for environment reconstruction; (ii) the second set of network state information for environment reconstruction; and/or (iii) a representation of at least one metric associated with the at least one network functionality to be configured. The method also includes determining, based on the output of executing the third AI/ML model, information for configuring the at least one network functionality. The method also includes configuring, based on the information, the at least one network functionality.

In an exemplary embodiment, the third AI/ML model is based on the union of the first AI/ML model and the second AI/ML model.

In an exemplary embodiment, the first AI/ML model and/or the second AI ML model are part of an AI/ML process in the group of: a supervised learning process, a deep learning process, a reinforcement learning process, a contextual multi-armed bandit process, an autoregression process, and/or combinations thereof.

In an exemplary embodiment, the first AI/ML model and/or the second Al ML model are part of a reinforcement learning process and the reinforcement learning process used is one of: a deep reinforcement learning process, an actor-critic process, a policy gradient process, or an off-policy reinforcement learning process, an offline reinforcement learning process.

In an exemplary embodiment, the first AI/ML model and/or the second AI/ML model are one of: a feedforward neural network, a deep neural network, a recurrent neural network, a convolutional neural network, a graph neural network, a graph attention network, a transformer, and/or a generative pretrained transformer.

In an exemplary embodiment, the first AI/ML model is one of: a graph neural network, a graph attention network, a transformer, or a generative pretrained transformer; and the second AI/ML model is part of a reinforcement learning process.

In an exemplary embodiment, the method further includes obtaining a first training data set based on the first set of network state information, comprising static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells; and training the first AI/ML model using the first training data set.

In an exemplary embodiment, the method further includes obtaining a second training data set based on one or more of: (i) the first set of network state information, comprising static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells; (ii) the second set the second set of network comprising dynamically changing information characterizing one or more of: a state associated to the network functionality to be configured; information associated to a state of network nodes, radio cells or user devices involved with the network functionality; measurements or predictions of signal strength or signal quality; measurements or predictions or cell load information and/or cell capacity information; measurements or predictions of energy consumption or an energy saving mode for user devices, radio cells or network nodes; observable dynamics of the at least one network functionality to be configured, information associated to the state of the first network node, and/or to the state of at least a second network node, and/or to the state of at least a user device; information associated to the state dynamics of at least a functionality a network node or a radio cell; and/or information associated to the state dynamics of at least a functionality a user device; (iii) an indication of at the least one information determined by the first network node to configure the at least one network functionality; and/or (iv) an indication of a reward associated to the information determined by the first network node to configure the at least one network functionality; and training the second AI/ML model using the second training data set.

In an exemplary embodiment, the method further includes the first network node determining one or more training data sets for training one or more of: the first AI/ML model, the second AI/ML model, and/or the third AI/ML model; and wherein the one or more training data sets includes one or more of: (i) the first set of network state information, comprising static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells; (ii) the second set the second set of network comprising dynamically changing information characterizing one or more of: a state associated to the network functionality to be configured; information associated to a state of network nodes, radio cells or user devices involved with the network functionality; measurements or predictions of signal strength or signal quality; measurements or predictions or cell load information and/or cell capacity information; measurements or predictions of energy consumption or an energy saving mode for user devices, radio cells or network nodes; observable dynamics of the at least one network functionality to be configured, information associated to the state of the first network node, and/or to the state of at least a second network node, and/or to the state of at least a user device; information associated to the state dynamics of at least a functionality a network node or a radio cell; and/or information associated to the state dynamics of at least a functionality a user device; (iii) an encoding reconstructing the environment where the at least one network functionality to be configured is operating; (iv) a representation of at least one metric associated with the at least one network functionality to be optimized; (v) an indication of at the least one information determined by the first network node to configure the at least one network functionality; and/or (vi) an indication of a reward associated to the information determined by the first network node to configure the at least one network functionality.

In an exemplary embodiment, obtaining a first set of network state information for reconstructing the environment to configure the at least one network functionality includes one or more of: (i) obtaining information related to the first set of network state information from at least a second network node and/or from at least a user device; (ii) obtaining information related to the first set of network state information for environment reconstruction based on one or more steps of: (a) receiving a FIRST MESSAGE from at least a second network node, the FIRST MESSAGE comprising assistance information related the first set of network state information; and/or (b) receiving a SECOND MESSAGE from at least a user device, the SECOND MESSAGE comprising assistance information related the first set of network state information; (iii) obtaining a first set of network state information for environment reconstruction for configuring the least one network functionality by internal processes and measurements.

In an exemplary embodiment, obtaining a first set of network state information for reconstructing the environment to configure the at least one network functionality includes one or more of: (i) transmitting a request message to at least one second network node and/or to at least one user device, the request message requesting to obtain assistance information related the first set of network state information, and receiving a FIRST MESSAGE and/or the SECOND MESSAGE from the second network node and/or from the user device in response to the request message; and/or (ii) transmitting to a second network node and/or to a user device information related to the determined information for configuring the at least one network functionality.

In an exemplary embodiment, obtaining a second set of network state information for reconstructing the environment to configure the at least one network functionality includes one or more of: (ii) obtaining information related to the second set of network state information from at least a second network node; and/or (ii) obtaining information related the second set of network state information for environment reconstruction based on one or more of: (a) receiving a THIRD MESSAGE from at least the second network node comprising assistance information related to the second set of network state information for environment reconstruction for least one network functionality to be configured by the first network node; (b) transmitting a FOURTH MESSAGE to a second network node, the FOURTH MESSAGE requesting one or more types of assistance information related to the second set of network state information to the second network node; and/or (c) receiving the assistance information related to the second set of network state information with the THIRD MESSAGE, conditioned to or triggered by or dependent on the transmission of the FOURTH MESSAGE.

In an exemplary embodiment, obtaining a second set of network state information for reconstructing the environment to configure the at least one network functionality includes one or more of: (i) obtaining information related to the second set of network state information from at least a user device; and/or (ii) obtaining information related the second set of network state information for environment reconstruction based on one or more of: (a) receiving a FIFTH MESSAGE from at least a user device, the FIFTH MESSAGE comprising assistance information related to the second set of network state information for environment reconstruction for at least one network functionality to be configured by the first network node; (b) transmitting a SIXTH MESSAGE to the user device, the SIXTH MESSAGE requesting one or more types of assistance information related to the second set of network state information to the user device; and/or (c) receiving the assistance information related to the second set of network state information with the FIFTH MESSAGE, conditioned to or triggered by or dependent on the transmission of the SIXTH MESSAGE.

In an exemplary embodiment, obtaining a first set of network state information for reconstructing the environment to configure the at least one network functionality includes obtaining information related to the first set of network state information from at least a second network node and/or from at least a user device; and wherein obtaining a second set of network state information for reconstructing the environment to configure the at least one network functionality includes obtaining information related to the second set of network state information from at least a second network node and/or from at least a user device.

In an exemplary embodiment, obtaining a first training data set and/or a second training data set associated to one or more of the first AI/ML model, the second AI/ML model and/or the third AI/ML model includes one or more of: (i) transmitting a SEVENTH MESSAGE to a third network node, the SEVENTH MESSAGE comprising at least one training data set associated to the first AI/ML model, or the second AI/ML model, or both; (ii) receiving from the third network node an EIGHTH MESSAGE, the EIGHTH MESSAGE comprising one of more of: (a) the first AI/ML model or an updated version of the first AI/ML model; (b) the second AI/ML model or an updated version of the second AI/ML model; and/or (c) the third AI/ML model or an updated version of the third AI/ML model, wherein the third Al model comprises a combination of the first AI/ML model and the second AI/ML model; and/or (iii) receiving a NINETH MESSAGE from the third network node, the NINETH MESSAGE requesting the first network node to provide one or more training data sets comprising one of more of: (a) the first AI/ML model; (b) the second AI/ML model; and/or (c) the third AI/ML model representing the joint combination of the first AI/ML model and the second AI/ML model.

According to a fourth aspect of the present disclosure, a network node is provided. The network node may include one or more memories comprising instruction data representing a set of instructions and one or more processors configured to communicate with the one or more memories and to execute the set of instructions, wherein the set of instructions, when executed by the processor, cause the processor to perform the methods of any of the embodiments of the first, second, and third aspects.

According to a fifth aspect of the present disclosure, a computer program is provided. The computer program includes instructions which, when executed by processing circuitry, cause the processing circuitry to carry out the methods of any of the embodiments of the first, second, and third aspects.

According to an sixth aspect of the present disclosure, a carrier containing the computer program of the fifth aspect is provided, and the carrier comprises one of an electronic signal, optical signal, radio signal or computer readable storage medium.

According to a seventh aspect of the present disclosure, a computer program product is provided. The computer program product includes non-transitory computer readable media having stored thereon the computer program of the fifth aspect.

According to a eighth aspect of the present disclosure, an apparatus is provided. The apparatus includes a memory and processing circuitry coupled to the memory. The apparatus is configured to perform the methods of any of the embodiments of the first, second, and third aspects.

Exemplary embodiments disclosed herein provide signaling aspects for a network node to acquire the information necessary to execute the Al model or algorithm from at least a second network node and/or at least a user device, such information comprising one or more of:
assistance information related to environment reconstruction
assistance information associated to the state of at least one network functionality to be optimized

Exemplary embodiments disclosed herein provide design aspects related to the generalization of an Al model or algorithm, including type of models, their concatenation, and training.

Exemplary embodiments disclosed herein provide a method executed by a first network node in a communication network, such as a radio access network (RAN), to generalize the design of at least one Al algorithm intended optimize at least one network functionality, the method comprising one or more steps of:

Obtaining a first set of network state information for environment reconstruction for optimizing the least one network functionality
Determining an encoding reconstructing the environment where the network functionality is operating based on the first set of network state information for environment reconstruction
Determining one or more parameters or instructions to optimize the network functionality based on one or more of
   a) The encoding reconstructing the environment where at least one functionality to be optimized is operating
   b) A representation of at least one intent, objective, or KPI—i.e., herein generally referred to as a metric—associated to the at least one functionality of the communication network to be optimized
Causing a change in the network functionality base on the determined parameters or instructions

Exemplary embodiments disclosed herein provide the method executed by the first network node may further comprise one or more steps of:
Obtaining a second set of network state information for environment reconstruction for optimizing the least one network functionality
Determining one or more parameters or instructions to optimize the network functionality based on one or more of
   a) The encoding reconstructing the environment where at least one functionality to be optimized is operating
   b) The second set of network state information for environment reconstruction
   c) A representation of at least one intent, objective, or KPI—i.e., herein generally referred to as a metric—, associated to the at least one functionality of the communication network to be optimized
Causing a change in the network functionality base on the determined parameters or instructions.

In an exemplary embodiment of the methods disclosed herein:
The first set of network state information provides a representation of static and/or semi-static state information characterizing a local network environment with respect to a reference service cell, or a reference serving network node or a reference user device.
The second set of network state information provides a representation of dynamically changing state information charactering the network functionality to be optimized within a local network environment with respect to a reference service cell, or a reference serving network node or a reference user device.
Describe how the local environment can be characterized by means of a graph representation based on the first set and the second set of the network state information

Exemplary embodiments of the methods disclosed herein describe:
How the herein referred to operations of determining may be realized by means of a first Al model and a second Al model, or by a single (i.e. a third) Al model, wherein
   a) The first Al model uses static and/or semi-static information charactering a local network environment provided by the first set of network state information
   b) The second Al model uses dynamically changing state information characterizing a local network environment provided by the first set of network state information and/or the output of the first Al model
   c) The third Al model jointly uses
      i. static and/or semi-static information charactering a local network environment provided by the first set of network state information
      changing state information charactering a local network environment provided by the first set of network state information
Methods to train the Al models disclosed by the invention, including
   a) Al model design (e.g., type of Al models and Al algorithms)
   b) Format of the required training samples
   c) Signaling aspects required to exchange training samples and/or Al models

Exemplary embodiments of the methods disclosed herein describe:
How the herein referred to operations of obtaining a first set of network state information and a second set of network state information may include obtaining information related to the first set of network state information and/or the second set of network state information from at least a second network node and/or from at least a user device, and the related signaling exchange.

Exemplary embodiments may provide one or more of the following technical advantage(s). By enabling generalization of an Al algorithm design, exemplary methods disclosed herein solve several issues of the related art. One advantage is that by enabling generalization of the Al design over the communication network environment, exemplary methods disclosed herein allow to train, deploy and lifecycle manage a single (or just a few) AI model(s) across the entire network for optimizing the one or more network operations. This improves scalability and performance.

Another advantage of the exemplary methods disclosed herein is to enable training Al models robust against the diversity and the dynamics of the radio environment, thus requiring less frequent Al model updates. This reduces the complexity of the lifecycle management, as well as the associated signaling overhead (e.g., for model performance monitoring and model update deployment), thereby providing also a reduction in energy consumption.

Another advantage achieved by the exemplary methods disclosed herein, by enabling generalization of the AI design over the communication network, is to simplify the generation, collection and management of training data. The generation of the training data can be distributed across all network entities, thus requiring fewer training data samples to be generated and collected by each individual network entity. This reduces signaling overhead, as well as duplication of hardware capabilities (such as storage capabilities) in each of the distributed network entities. The reduced signaling overhead improves system performance in terms of throughput and spectral efficiency.

### BRIEF DESCRIPTION OF THE DRAWINGS

The accompanying drawings, which are incorporated herein and form part of the specification, illustrate various embodiments.

FIG. 1 illustrates the current 5G RAN (a.k.a., the Next Generation RAN (NG-RAN)) architecture.

FIG. 2 illustrates the overall architecture for separation of gNB-CU-CP and gNB-CU-UP.

FIG. 3 illustrates a flowchart according to an embodiment.

FIG. 4 illustrates a flowchart according to an embodiment.

FIG. 5 is a block diagram of a communication network environment illustrating a method according to an embodiment.

FIG. 6 illustrates a flowchart according to an embodiment.

FIG. 7 is a block diagram of a communication network environment illustrating a method according to an embodiment.

FIG. 8 illustrates a flowchart according to an embodiment.

FIG. 9 illustrates a flowchart according to an embodiment.

FIG. 10 is a block diagram of a communication network environment illustrating a method according to an embodiment.

FIG. 11 illustrates a flowchart according to an embodiment.

FIG. 12 illustrates a flowchart according to an embodiment.

FIG. 13 is a block diagram of a communication network environment illustrating a method according to an embodiment.

FIG. 14 illustrates a flowchart according to an embodiment.

FIG. 15 illustrates a flowchart according to an embodiment.

FIG. 16 is a block diagram of a communication network environment illustrating a method according to an embodiment.

FIG. 17 illustrates a message flow diagram according to an embodiment.

FIG. 18 illustrates a message flow diagram according to an embodiment.

FIG. 19 illustrates a message flow diagram according to an embodiment.

FIG. 20 illustrates a message flow diagram according to an embodiment.

FIG. 21 illustrates a message flow diagram according to an embodiment.

FIG. 22 is a block diagram of an apparatus according to an embodiment.

FIG. 23 is a block diagram of an apparatus according to an embodiment.

FIG. 24 is a block diagram of a node according to an embodiment.

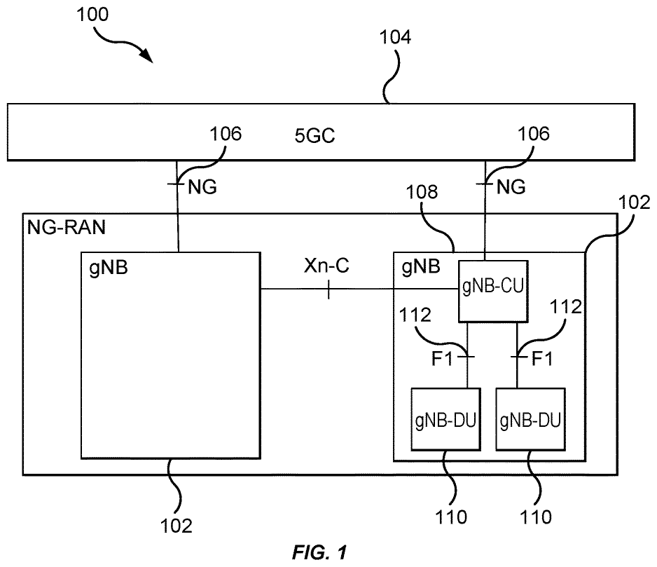

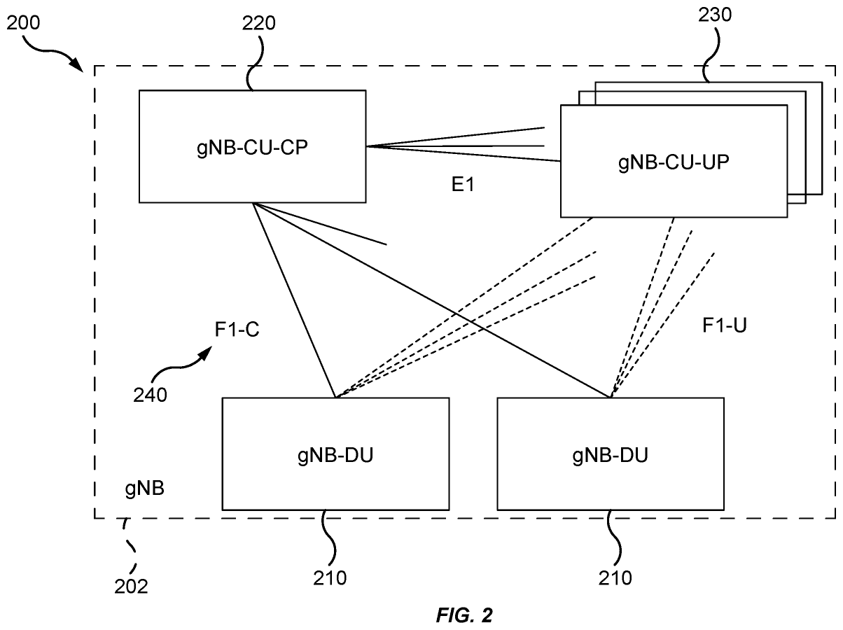

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the document provided in the Appendix.

A network node can be a RAN node, an OAM, a Core Network node, an OAM, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a UE.

The terms model training, model optimizing, model optimization, model updating are used herein interchangeably with the same meaning unless explicitly specified otherwise.

The terms model changing, modifying or similar are used herein interchangeably with the same meaning unless explicitly specified otherwise. In particular, they refer to the fact that the type, structure, parameters, connectivity of an AI/ML model may have changed compared to a previous format/configuration of the AI/ML model.

The terms Al model, AI/ML model, Al policy, AI/ML policy, Al algorithm, AI/ML algorithm, Al process, AI/ML process, as well the terms, model, policy or algorithm are used herein interchangeably with the same meaning unless explicitly specified otherwise.

References to “network nodes” herein should be understood such that a network node may be a physical node or a function or logical entity of any kind, e.g. a software entity implemented in a data center or a cloud, e.g. using one or more virtual machines, and two network nodes may well be implemented as logical software entities in the same data center or cloud.

The methods of the embodiments disclosed herein are independent with respect to specific AI/ML model types or learning problems/setting (e.g. supervised learning, unsupervised learning, reinforcement learning, hybrid learning, centralized learning, federated learning, distributed learning).

Non limiting examples of AI/ML algorithms may include supervised learning algorithms, deep learning algorithms, reinforcement learning type of algorithms (such as DQN, A2C, A3C), contextual multi-armed bandit algorithms, autoregression algorithms, and/or combinations thereof.

Such algorithms may exploit functional approximation models, hereafter referred to as AI/ML models, such as neural networks (e.g. feedforward neural networks, deep neural networks, recurrent neural networks, convolutional neural networks, graph neural networks, graph attention networks, transformers, and/or a generative pretrained transformer).

Examples of reinforcement learning algorithms may include deep reinforcement learning (such as deep Q-network (DQN), proximal policy optimization (PPO), double Q-learning), actor-critic algorithms (such as Advantage actor-critic algorithms, e.g. A2C or A3C, actor-critic with experience replay), policy gradient algorithms, off-policy learning algorithms.

### Methods for a First Network Node

### FIRST VARIANT: First Set and Second Set of Network State Information

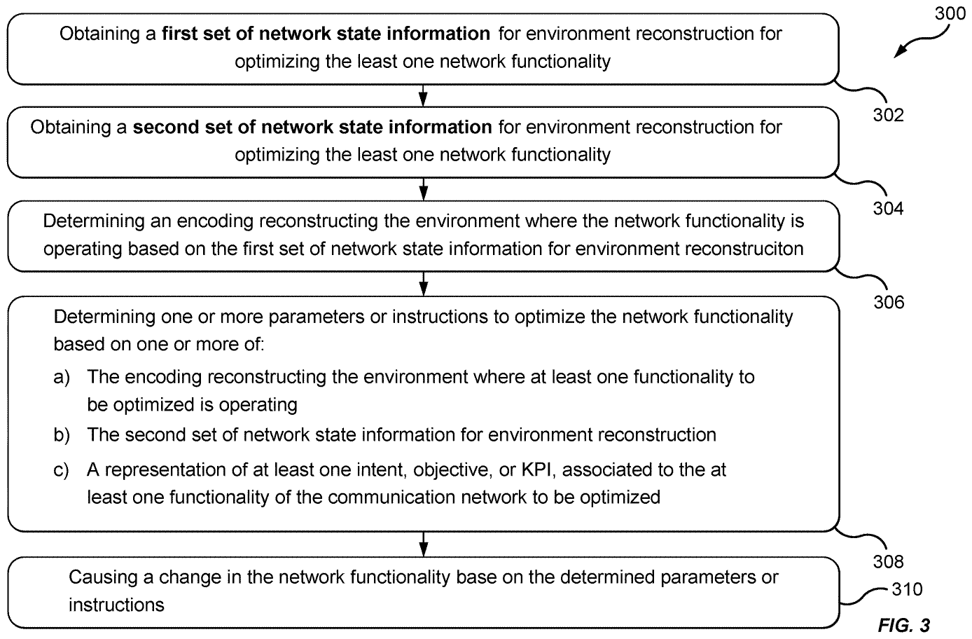

Embodiments disclosed herein provide a method executed by a first network node in a communication network, such as a radio access network (RAN), to generalize the design of at least one Al algorithm intended to optimize at least one network functionality. FIG. 3 illustrates a flowchart according to an embodiment. With reference to FIG. 3, the method 300 comprises one or more steps of:
302—Obtaining a first set of network state information for environment reconstruction for optimizing the least one network functionality
302—Obtaining a second set of network state information for environment reconstruction for optimizing the least one network functionality
304—Determining an encoding reconstructing the environment where the network functionality is operating based on the first set of network state information for environment reconstruction
306—Determining one or more parameters or instructions to optimize the network functionality based on one or more of:
   a) The encoding reconstructing the environment where at least one functionality to be optimized is operating
   b) The second set of network state information for environment reconstruction
   c) A representation of at least one intent, objective, or KPI, associated to the at least one functionality of the communication network to be optimized
Causing a change in the network functionality base on the determined parameters or instructions.

In one embodiment, the first network node determines the encoding reconstructing the environment where the network functionality is operating based on a first Al model and a first encoding based on the first set of network state information for environment reconstruction and a second encoding based on the second set of network state information for environment reconstruction. In some examples, the first AI model may be designed to provide an encoding reconstructing the network environment associated to either the first network node, or to a serving cell of the first network node, or to a user device served by at least a serving cell of the first network node.

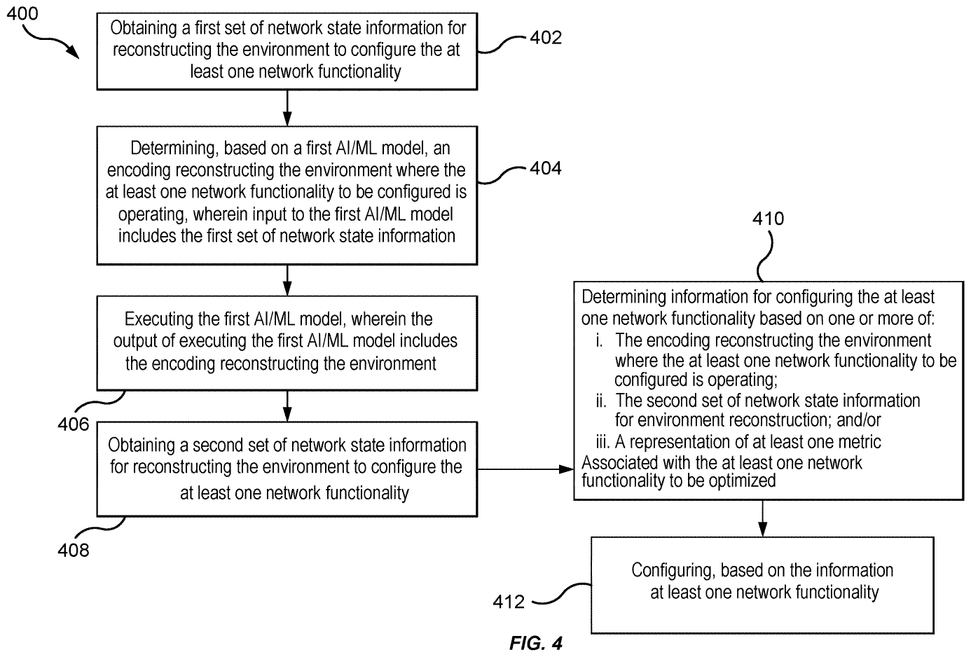

One approach, illustrated in FIG. 4, generates distinct encodings for static and dynamic information using separate functions, φ and φ, respectively. Graph representations, like graph neural networks, attention networks, transformers, etc. can be for the first AI model to obtain the encoding reconstructing the environment associated to the network functionality. The encoding produced by the first AI model captures topological and configuration relationships among RAN entities, with attention layers weighting the importance of the model input information and their interrelations. This method improves feature robustness by reducing the sensitivity to input pre-selection required by feature engineering. Furthermore, the first AI model learned to encode the environment of a first RAN functionality can be repurposed for various RAN functions.

Further, separating environment information by timescales enables new approaches for state reconstruction. In the approach, as illustrated in FIG. 4, two distinct encodings for reconstructing the environment are generated: a first encoding based on the first set of network state information representing static environment information, such as RAN deployment, RAN configurations, transmission technology etc. ; a second encoding based on the second set of network state information representing dynamic information specific to the state of a RAN functionality controlled by the first network node.

Graph representations, like graph neural networks, attention networks, transformers, etc. can be for the first AI model to obtain the first encoding reconstructing the environment associated to the network functionality. The first encoding produced by the first AI model captures topological and configuration relationships among RAN entities, with attention layers weighting the importance of the model input information and their interrelations. This method improves feature robustness by reducing the sensitivity to input pre-selection required by feature engineering. Furthermore, the first AI model learned for a specific RAN functionality can be repurposed for various RAN functions, combined with specific design choices for determining the second encoding of dynamic environment information. One choice may entail an identity function, as in feature engineering. Another choice may entail advanced ML methods for feature learning, such as autoencoders.

FIG. 4 is a flowchart illustrating a process 400 according to an embodiment. Process 400 is a computer-implemented method, executed by a first network node in a communication network environment, for generalizing design of at least one artificial intelligence/machine learning (AI/ML) model for configuring at least one network functionality in the environment. Process 400 may begin with step 402.

Step 402 comprises obtaining a first set of network state information for reconstructing the environment to configure the at least one network functionality.

Step 404 comprises determining, based on a first AI/ML model, an encoding reconstructing the environment where the at least one network functionality to be configured is operating, wherein input to the first AI/ML model includes the first set of network state information.

Step 406 comprises executing the first AI/ML model, wherein the output of executing the first AI/ML model includes the encoding reconstructing the environment.

Step 408 comprises obtaining a second set of network state information for reconstructing the environment to configure the at least one network functionality.

Step 410 comprises determining information for configuring the at least one network functionality based on one or more of:
i. the encoding reconstructing the environment where the at least one network functionality to be configured is operating;
ii. the second set of network state information for environment reconstruction; and/or
iii. a representation of at least one metric associated with the at least one network functionality to be optimized.

Step 412 comprises configuring, based on the information, the at least one network functionality.

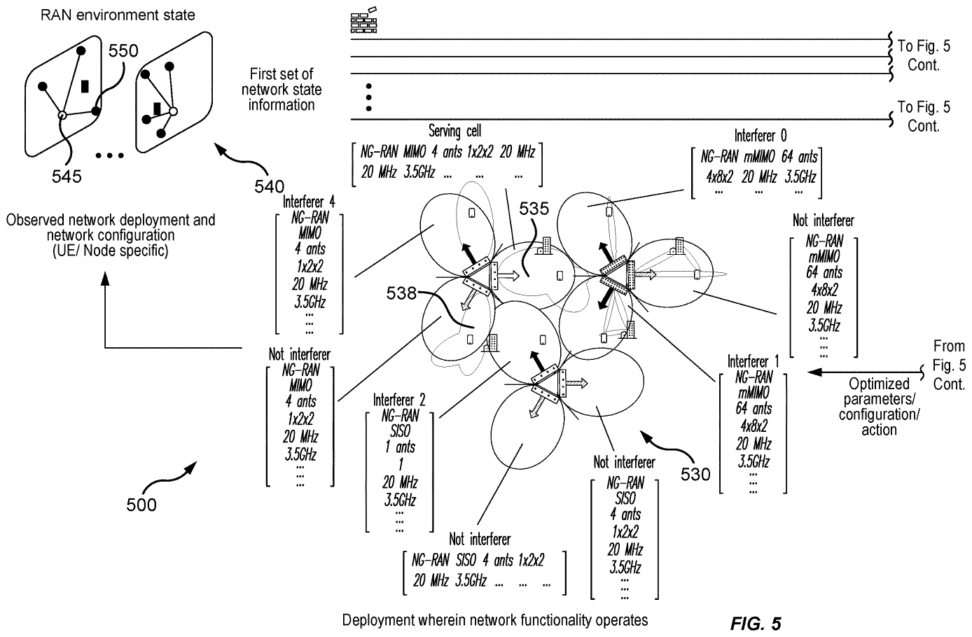

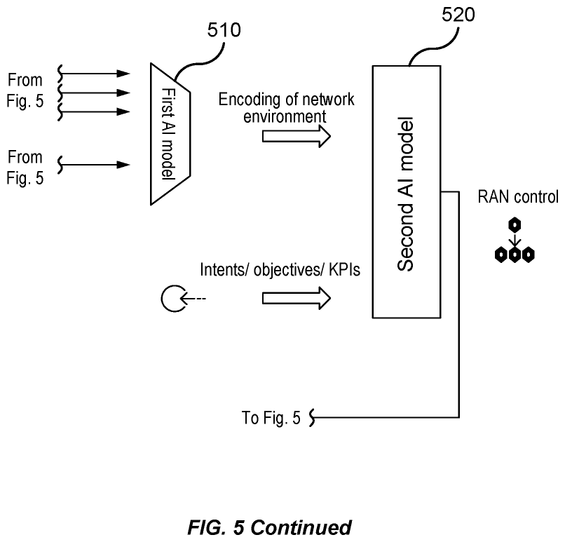

FIG. 5 is a block diagram 500 of a communication network environment illustrating a method according to an embodiment. In one possible realization of the model, illustrated in FIG. 5, the first network node executes the first AI model 510 using the first set of network state information as input information.

In one embodiment of the method, illustrated in FIG. 5, the first network node may determine parameters or instructions to optimize the network functionality based on a second AI model 520. In one possible implementation of this embodiment, the first network node may use as input information to the second AI model one or more of:
The encoding reconstructing the environment where at least one functionality to be optimized is operating
A representation of at least one intent, objective, or KPI, associated to the at least one functionality of the communication network to be optimized

In one embodiment of the method, the first network node may alternatively
Determine one or more parameters or instructions to optimize the network functionality based on one or more of
   a) The first set of network state information for environment reconstruction
   b) A representation of at least one intent, objective, or KPI, associated to the at least one functionality of the communication network to be optimized In this case, the first network node may not need to determine an encoding reconstructing the network environment to determine one or more parameters or instructions to optimize the network functionality, but directly uses the first set of network state information for environment reconstruction to determine parameters or instructions to optimize the network functionality.

In one embodiment of the method, as illustrated in FIG. 5, a graph representation, for example a graph neural network (GNN), could be used to learn an embedding from static (or semi-static) information describing a local network deployment 530, as seen from the perspective of a radio node, or a radio cell, or a user device. The user's service cell or the serving network node 535, and the most relevant neighboring interfering radio cells or network nodes 538 are illustrated. This approach can be used for learning a representation of the local RAN deployment, but not for state information describing the dynamic of a RAN functionality.

Static information used to describe such local network environment may include, for instance:
Information characterizing nodes/cells locations;
Relational information between nodes and cells.
   Carefully selecting this type of information, allows to fulfil the permutation invariant and permutation equivariance properties required for GNN.

For example, the local network deployment 530 seen from the perspective of the user device in the cell 535 can be represented by the star graph 540, in which the center node 545 of the graph represents the serving cell, and the surrounding nodes 550 represent the most relevant interfering cells. Using this type of information (e.g., cell type, location, type of antenna array, distance between cells, etc.), provides for fulfilling the permutation invariant and permutation equivariance properties required for GNN.

In one possible realization of this embodiment, the first network node determines the parameters or instructions to optimize the network functionality based on a single AI model, such as a third AI model requiring as inputs one or more of:
The first set of network state information for environment reconstruction
A representation of at least one intent, objective, or KPI, associated to the at least one functionality of the communication network to be optimized.

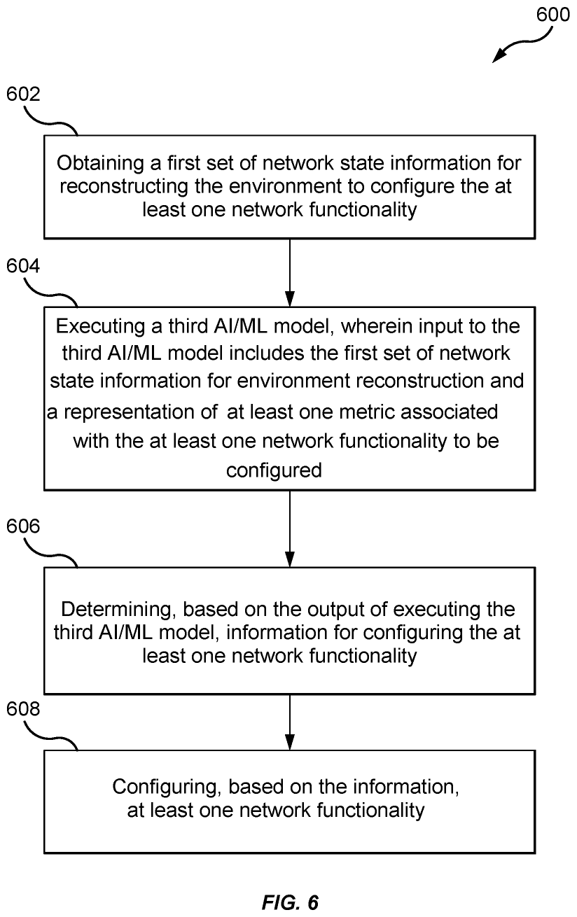

FIG. 6 is a flowchart illustrating a process 600 according to an embodiment. Process 600 is a computer-implemented method, executed by a first network node in a communication network environment, for generalizing design of at least one artificial intelligence/machine learning (AI/ML) model for configuring at least one network functionality in the environment. Process 600 may begin with step 602.

Step 602 comprises obtaining a first set of network state information for reconstructing the environment to configure the at least one network functionality.

Step 604 comprises executing a third AI/ML model, wherein input to the third AI/ML model includes the first set of network state information for environment reconstruction and a representation of at least one metric associated with the at least one network functionality to be configured.

Step 606 comprises determining, based on the output of executing the third AI/ML model, information for configuring the at least one network functionality.

Step 608 comprises configuring, based on the information, the at least one network functionality.

In one possible realization of this embodiment, the third AI model is represented by a combination (such as the union) of the first AI model and the second AI model into a single AI model. Thereby, the encoding of the environment reconstruction is seen as an internal process transparent to other operations (such as the training process of the third AI model).

### Embodiments Related to First Set of Network State Information

According to embodiments of the method, the first network node may determine an encoding reconstructing the network environment where the network functionality is operating based a first set of network state information for environment reconstruction.

The first set of network state information for environment reconstruction provides a snapshot of the state of the communication network (e.g., the network deployment and configuration of network nodes or radio cells) surrounding a user device, or a radio cell, or a network node. As such, the first set of network state information for environment reconstruction may comprise static and semi-static configuration information associated to network nodes and/or radio cells and/or use devices, information characterizing their deployment and geometry, information characterizing the radio environment wherein network nodes or radio cells are deployed, information characterizing the deployment area wherein network nodes or radio cells are deployed, as well as information characterizing the relation between a group of network nodes or between a group of radio cells. Therefore, the first set of network state information may comprise information directly available or observable at the first network node, as well as information that the first network node may obtain from at least a second network node and/or at least a user device.

The first set of network state information and/or the encoding reconstructing the network environment are obtained with respect to one of
The first network node or a neighboring network node. We refer to this case as network-node-centric state information or environment reconstruction.
One or more radio cells, e.g., a serving cell controlled by the first network node. We refer to this case as cell-centric state information or environment reconstruction.
One or more user devices, e.g., a user device served by at least a radio cell controlled by the first network node. We refer to this case as user-centric state information or environment reconstruction.

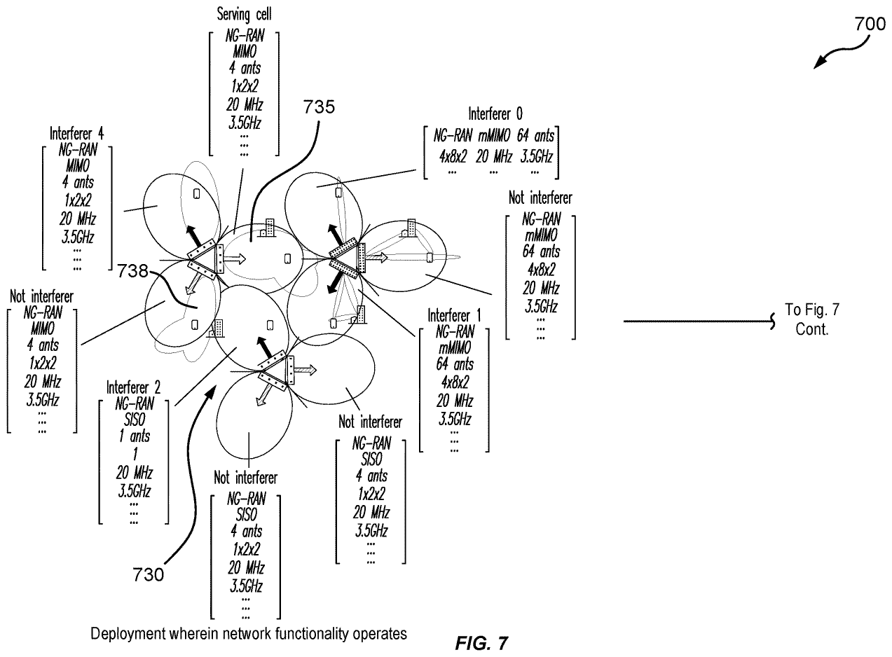

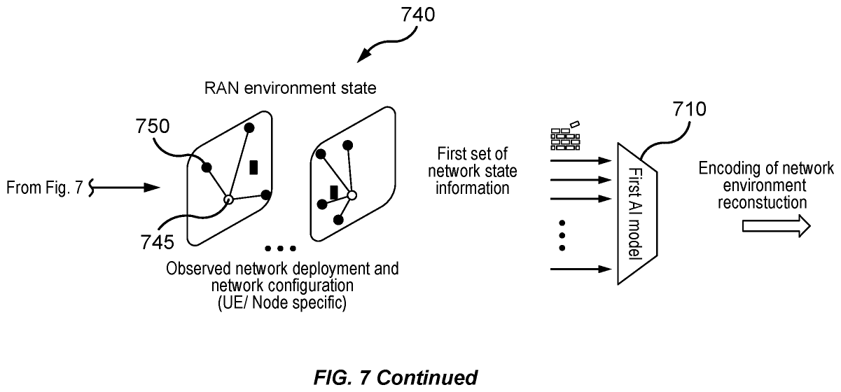

FIG. 7 is a block diagram of a communication network environment 700 illustrating a method according to an embodiment. In one embodiment of the method, illustrated FIG. 7, the first set of network state information for environment reconstruction is represented in the form of a graph. Therefore, the graph representing the first set of network state information may be constructed as network-centric, cell-centric, and/or user-centric, wherein a node in the graph may represent a network node, a radio cell or a user device in the radio environment, whereas an edge connecting two nodes in the graph represents a relation between any of: two or more network nodes, two or more radio cells, two or more user device, any combination of at least a network node, at least a radio cell, at least a user device of the graph. One or more information elements of the first set of network state information may characterize a node in the graph, and/or an edge in the graph edges representing a relation between two nodes in the graph.

FIG. 7 illustrates a non-limiting example of a user-centric graph representing the first set of network state information. In this example, the local network deployment 730, the user's service cell or the serving network node 735, and the most relevant neighboring interfering radio cells or network nodes 738 are illustrated. In this example, a connection between two nodes in the graph is created if a direct or indirect communication interface exists between the service cell/node and the neighboring interfering cells/nodes. In this example, the user-centric graph representing the first set of network state information is used as input information to a first AI model 710 trained to provide an encoding reconstructing the network environment. FIG. 7 includes star graph 740, in which the center node 745 of the graph represents the serving cell, and the surrounding nodes 750 represent the most relevant interfering cells.

Obtaining a network-centric or cell-centric graph representing the first set of network state information may require the first network node to obtain information characterizing a set of radio cells or network nodes surrounding a reference network node or radio cells that are relevant to or may influence the performance of the reference network node or radio cell in terms, for instance, of coverage, capacity.

Obtaining a user-centric graph representing the first set of network state information may require the first network node to obtain information characterizing the set of radio cells or network nodes surrounding a reference user device, which are relevant to or may influence the radio signal transmitted or received by the reference user device.

In one embodiment, state information for environment reconstruction may include one or more of:
An identifier of a reference network node and/or radio cell and/or user device for environment reconstruction
A list of at least one neighboring network node of the reference network node or the reference radio cell or the reference user. For each neighboring network node, state information for environment reconstruction may further comprise one or more of:
   a) Configuration information associated to the network node
   b) Deployment configuration, which may include one or more of
      i. An indication of the geographical location of the network node
      ii. An indication of the type of deployment area where the network node is located, such as rural, urban, dense urban, etc.
      A 2D or a 3D map describing the location of the network node deployment and the surrounding area
      iv. A radio environmental map describing the signal strength or the signal attenuation in the area surrounding the network node.
A list of at least one neighboring radio cell of the reference network node or the reference radio cell or the reference user. For each neighboring radio cell, state information for environment reconstruction may further comprise one or more of:
   a) TDD or FDD configuration information, such as uplink and/or downlink frequency information including, for instance, supported primary and supplementary operating bands, and Frequency Shift, supported or used TDD mode, etc.
   b) Uplink power control hyperparameters for open loop power control
   c) Measurement Timing Configuration
   d) Antenna array configuration information including, for instance, one or more of
      i. An identifier of the antenna array
      ii. The type of antenna array, such as MIMO, massive MIMO, etc.
      iii. The type of beamforming supported
      iv. The number of antenna elements supported
      v. The polarization configuration of the supported antenna elements
      vi. The number of radio-frequency chains supported
      vii. An indication of the height of at least one antenna array used by the second network node
      viii. An indication of the orientation of the antenna array used by the second network node. In one example, the antenna array orientation may be expressed with respect to longitude and latitude spatial coordinates.
      ix. An indication of the vertical tilt of the antenna array. The indicated antenna tilt could be a mechanical tilt, an electrical tilt or both

In one embodiment, state information for environment reconstruction may include one or more of:
An identifier of a reference user device for environment reconstruction
An indication of Antenna array configuration information including, for instance, one or more of
   a) An identifier of the antenna array
   b) The type of antenna array, such as MIMO, massive MIMO, etc.
   c) The type of beamforming supported
   d) The number of antenna elements supported
   e) The polarization configuration of the supported antenna elements
   f) The number of radio-frequency chains supported
   g) An indication of the height of at least one antenna array used by the second network node
   h) An indication of the orientation of the antenna array used by the second network node. In one example, the antenna array orientation may be expressed with respect to longitude and latitude spatial coordinates.
   i) An indication of the vertical tilt of the antenna array. The indicated antenna tilt could be a mechanical tilt, an electrical tilt or both
An indication of the user device manufacturer
An indication of the user device model
An indication of the user device software type and/or version
An indication of the user device battery level
An indication of the chipset type or chipset model
An indication of the user device context information, as defined for instance by the E-UTRAN or NG-RAN systems,
A list of at least one neighboring radio cells relevant for user-centric environment reconstruction
A list of reference signal beams of neighboring radio cells relevant for user-centric environment reconstruction, wherein reference signal beams may be indicated by at least one identifier and/or type of reference signal (e.g., CSI-RS signal, SSSB signal, etc.)
A list of radio signal measurements, associated to neighboring radio cells or reference signals thereof, relevant for user-centric environment reconstruction, such as reference signal received power, signal to noise ratio, signal to noise and interference ration, quality of experience, reference signal strength indicator, etc

### Embodiments Related to Representation of KPIs

Non-limiting examples of intents, objectives or KPIs that the network node may use to optimize the at least one network functionality may include:
Intents, objectives or KPIs associated to a user device, such as spectral efficiency, throughput, latency, packet error rate, bit error rate, energy consumption, energy saving.
Intents, objectives or KPIs associated to a radio cell, such as, cell coverage, cell capacity, cell spectral efficiency, cell throughput, latency, cell resource utilization, cell load.
Intents, objectives or KPIs associated to at least a network node, such as energy consumption, coverage, capacity, load.
Non-limiting examples of intents, objectives or KPIs may for example be: at least 95% of the URLLC user devices of a radio cell shall experience a latency of maximum 20 msec, at least 80% of the users devices shall have a minimum QoE (Quality of Experience) of 4.0 when streaming video of participating in conference video call, or energy consumption of a user device, network node or system shall be kept to a minimum.

### Example of Changes in the Network Functionality

The method may be adopted to optimize network functionalities operating a different level of the RAN protocol stack ranging, for instance, from physical layer (PHY) to medium access control (MAC), routing, transport, as well as application layer, network configuration and deployment, core network operations.

Non-limiting examples of PHY layer functionalities may comprise channel estimation, signal demodulation, decoding.

Non-limiting example of MAC layer functionalities may comprise link adaptation, radio resource allocation (such as user scheduling over time and frequency resources), power control, precoding.

Non-limiting examples of functionalities acting on network configuration may comprise mobility optimization, mobility load balancing, capacity and coverage optimization, energy saving configurations (for the first network node or its radio cells), cell shaping, network hyperparameters configuration, such as antenna tilt, control channel resources, semi-static uplink power control parameters, TTD configuration, FDD configuration, discontinuous transmission DTX configuration, discontinuous reception DRX configurations, configuration of downlink reference signals (such as SSB, CSI-RS, discovery reference signals), and network slicing such as configuration of network slices and allocation of radio resources to network slices or subscribers thereof.
In a non-limiting example, the first network node executes the method for optimizing link adaptation for one or more user devices, for a downlink or uplink transmission.
In this example, the first network node may use a first set of network state information providing a user-centric representation of the network environment, e.g., for the specific user device for which link adaptation is optimized.
In this example, the first network node may determine one or more link adaptation parameters, such as modulation and coding scheme, transmission rank, transport block size, etc. according to any of the previous embodiments.
The first network node may optimize link adaptation parameters based on one or more of spectral efficiency, throughput, latency, etc.
Therefore, in this case, the first network node may cause a change in the network functionality by means of adapting the transmission format of the user device based on the determined link adaptation parameters.

In a non-limiting example, the first network node executes the method for optimizing cell shaping for a radio cell of the first network node.
In this example, the first network node may use a first set of network state information providing a cell-centric representation of the network environment, e.g., for the specific radio cell for which the first network node desires to optimize coverage.
In this example, the first network node may determine a configuration parameter affecting coverage of the radio cell according to any of the previous embodiments.
The first network node may optimize link adaptation parameters based on one or more of spectral efficiency, throughput, latency, etc.
Therefore, in this case, the first network node may cause a change in the shape of the radio cell, such as its coverage area by applying the determined configuration parameters to the radio cell.

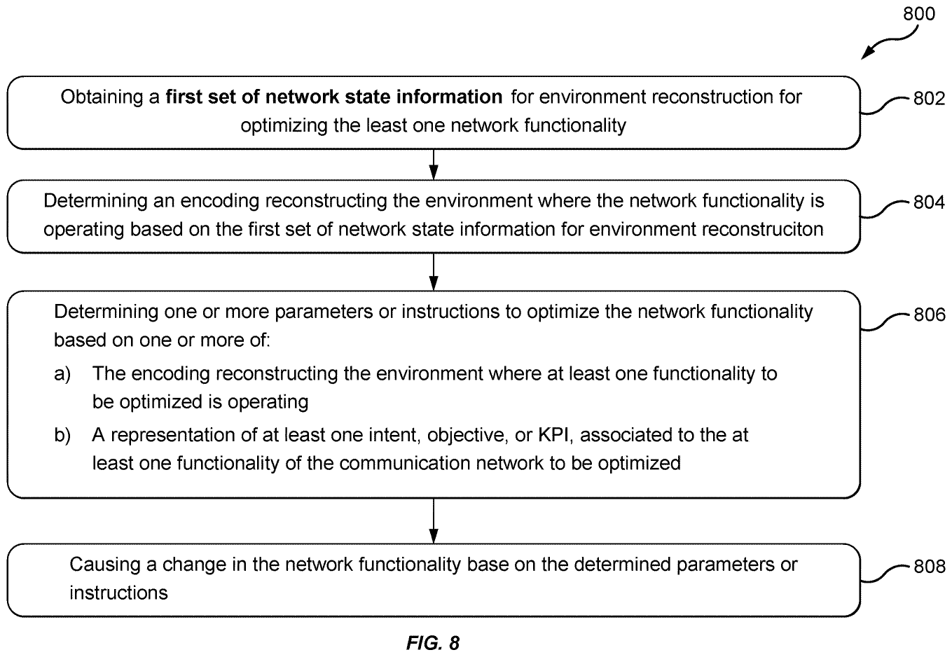

FIG. 8 illustrates a flowchart according to an embodiment. With reference to FIG. 8, the method 800 executed by the first network node may further comprise one or more steps of:
802—Obtaining a first set of network state information for environment reconstruction for optimizing the least one network functionality
802—Obtaining a second set of network state information for environment reconstruction for optimizing the least one network functionality
804—Determining an encoding reconstructing the environment where the network functionality is operating based on the first set of network state information for environment reconstruction
806—Determining one or more parameters or instructions to optimize the network functionality based on one or more of:
   a) The encoding reconstructing the environment where at least one functionality to be optimized is operating
   b) The second set of network state information for environment reconstruction
   c) A representation of at least one intent, objective, or KPI, associated to the at least one functionality of the communication network to be optimized
Causing a change in the network functionality base on the determined parameters or instructions.

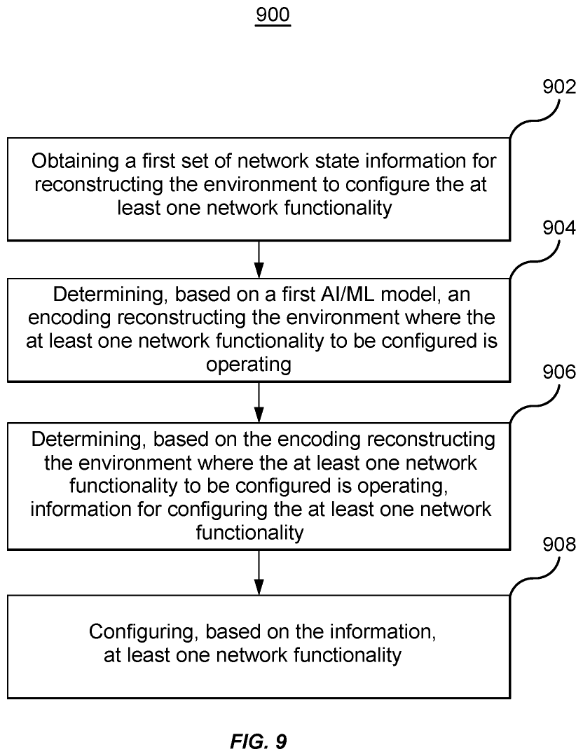

FIG. 9 is a flowchart illustrating a process 900 according to an embodiment. Process 900 is a computer-implemented method, executed by a first network node in a communication network environment, for generalizing design of at least one artificial intelligence/machine learning (AI/ML) model for configuring at least one network functionality in the environment. Process 900 may begin with step 902.

Step 902 comprises obtaining a first set of network state information for reconstructing the environment to configure the at least one network functionality.

Step 904 comprises determining, based on a first AI/ML model, an encoding reconstructing the environment where the at least one network functionality to be configured is operating.

Step 906 comprises obtaining a second set of network state information for reconstructing the environment to configure the at least one network functionality.

Step 908 comprises determining information for configuring the at least one network functionality based on one or more of:
i. the encoding reconstructing the environment where the at least one network functionality to be configured is operating;
ii. the second set of network state information for environment reconstruction; and/or
iii. a representation of at least one metric associated with the at least one network functionality to be optimized.

Step 910 comprises configuring, based on the information, the at least one network functionality.

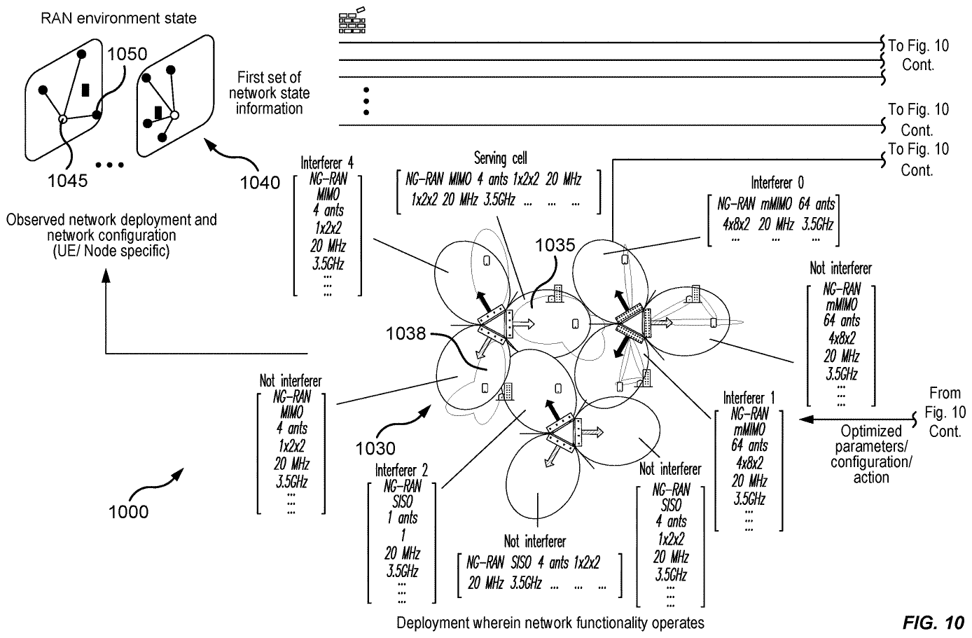

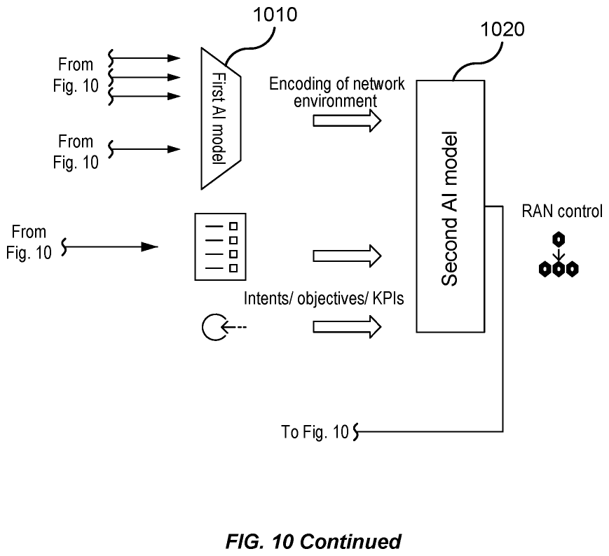

FIG. 10 is a block diagram of a communication network environment 1000 illustrating a method according to an embodiment. In one realization of this embodiment, illustrated in FIG. 10, the first network node may determine parameters or instructions to optimize the network functionality based on a second AI model 1020, using as input information to the second AI model one or more of:
a) The encoding reconstructing the environment where at least one functionality to be optimized is operating
b) The second set of network state information for environment reconstruction
c) A representation of at least one intent, objective, or KPI, associated to the at least one functionality of the communication network to be optimized.

In this example, the local network deployment 1030, the user's service cell or the serving network node 1035, and the most relevant neighboring interfering radio cells or network nodes 1038 are illustrated. FIG. 10 includes star graph 1040, in which the center node 1045 of the graph represents the serving cell, and the surrounding nodes 1050 represent the most relevant interfering cells.

In one embodiment, the second set of network state information for environment reconstruction may comprise information characterizing the observable dynamics of the one network functionality to be optimized.

Therefore, the method improves performance of the network functionality by means of Al technology optimized to generalize over any combination of three types of information:

Static and semi-static information, provided by the first set of network state information, representing, or characterizing the network deployment and topology, the network configuration (e.g., of network node, radio cells (or partitions thereof), user devices, etc.), and possibly statistical information related to the radio environment (e.g., distribution, geometry and statistical momentum of the signal-to-noise ratio, signal strength, etc., type of fading or scattering environment, etc).
Dynamically changing information, provided by the second set of network state information, representing or characterizing a state associated to the network functionality to be optimized, which may involve dynamic information associated to a state of network nodes, radio cells or user devices involved by the network functionality. In some examples, this type of information may include measurements or predictions of signal strength or signal quality, measurements or predictions or cell load information and/or cell capacity information, measurements or predictions of energy consumption or an energy saving mode for user devices, radio cells or network nodes, etc.
A representation of at least an intent, an objective, or a KPI that the network functionality is supposed to optimize or achieve.

In one embodiment of the method, the first network node may alternatively
Determine (300) one or more parameters or instructions to optimize the network functionality based on one or more of:
   a) The first set of network state information for environment reconstruction
   b) The second set of network state information for environment reconstruction
   c) A representation of at least one intent, objective, or KPI, associated to the at least one functionality of the communication network to be optimized.

A partition of a radio cell can be, in some examples, a portion of the radio cell coverage area, such as the coverage area of a downlink reference signal beam like an SSB signal beam of the 3GPP NG RAN system.

In one possible realization of this embodiment, the first network node determines (300) the parameters or instructions to optimize the network functionality based on a single AI model, such as a third AI model requiring as inputs one or more of:
The first set of network state information for environment reconstruction
The second set of network state information for environment reconstruction.
A representation of at least one intent, objective, or KPI, associated to the at least one functionality of the communication network to be optimized.

In one possible realization of this embodiment, the third AI model is represented by a combination (such as the union) of the first AI model and the second AI model into a single AI model. Thereby, the encoding of the environment reconstruction is seen as an internal process transparent to other operations (such as the training process of the third AI model).

### Embodiments related to Second Set of Network State Information

In one embodiment, the second set of network state information for environment reconstruction comprises information characterizing the observable dynamics of the one network functionality to be optimized. Depending on the network functionality to be optimized, its observable dynamics may comprise information associated to the state of the first network node, and/or to the state of at least a second network node, and/or to the state of at least a user device. Therefore, the second set of network state information may comprise information directly available or observable at the first network node, as well as information that the first network node may receive from at least a second network node and/or at least a user device.

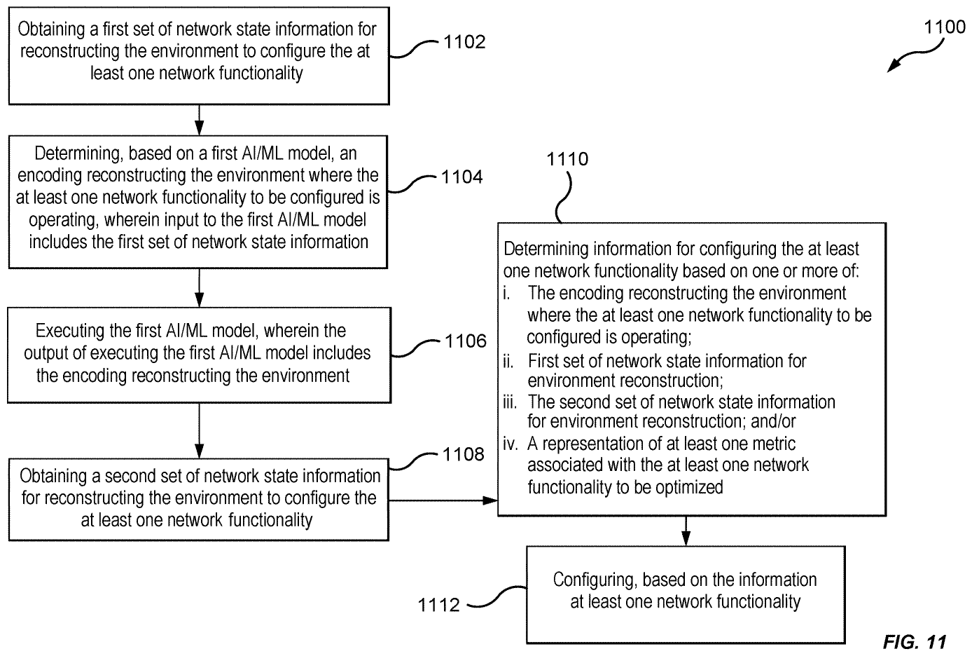

FIG. 11 is a flowchart illustrating a process 1100 according to an embodiment. Process 1100 is a computer-implemented method, executed by a first network node in a communication network environment, for generalizing design of at least one artificial intelligence/machine learning (AI/ML) model for configuring at least one network functionality in the environment. Process 1100 may begin with step 1102.

Step 1102 comprises obtaining a first set of network state information for reconstructing the environment to configure the at least one network functionality.

Step 1104 comprises, determining, based on a first AI/ML model, an encoding reconstructing the environment where the at least one network functionality to be configured is operating, wherein input to the first AI/ML model includes the first set of network state information.

Step 1106 comprises executing the first AI/ML model, wherein the output of executing the first AI/ML model includes the encoding reconstructing the environment.

Step 1108 comprises obtaining a second set of network state information for reconstructing the environment to configure the at least one network functionality.

Step 1110 comprises determining information for configuring the at least one network functionality based on one or more of:
i. the encoding reconstructing the environment where the at least one network functionality to be configured is operating;
ii. first set of network state information for environment reconstruction;
iii. the second set of network state information for environment reconstruction; and/or
iv. a representation of at least one metric associated with the at least one network functionality to be optimized.

Step 1112 comprises configuring, based on the information, the at least one network functionality.

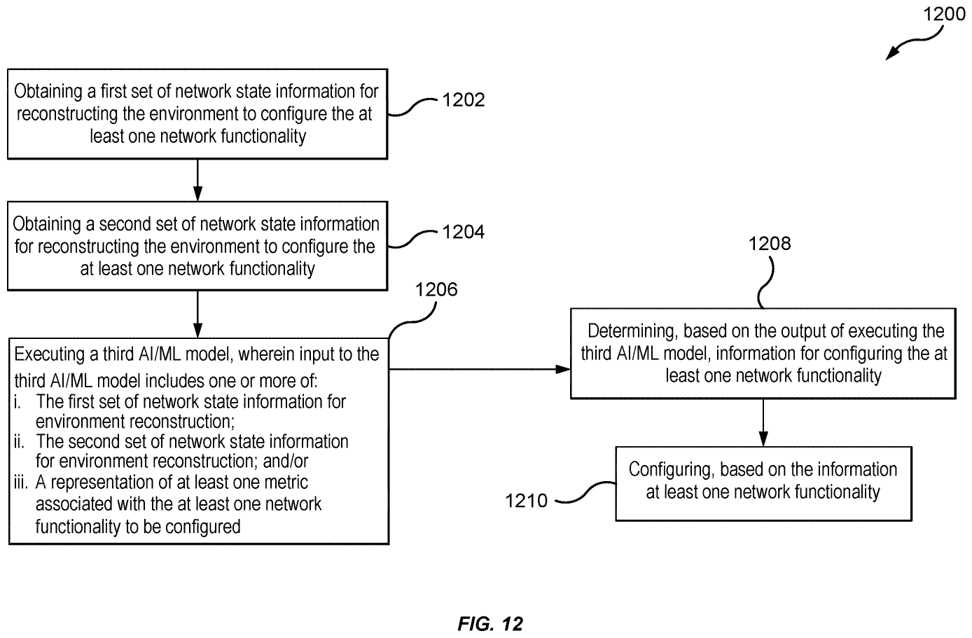

FIG. 12 is a flowchart illustrating a process 1200 according to an embodiment. Process 1200 is a computer-implemented method, executed by a first network node in a communication network environment, for generalizing design of at least one artificial intelligence/machine learning (AI/ML) model for configuring at least one network functionality in the environment. Process 1200 may begin with step 1202.

Step 1202 comprises obtaining a first set of network state information for reconstructing the environment to configure the at least one network functionality.

Step 1204 comprises obtaining a second set of network state information for reconstructing the environment to configure the at least one network functionality.

Step 1206 comprises executing a third AI/ML model, wherein input to the third AI/ML model includes one or more of:
i. the first set of network state information for environment reconstruction;
ii. the second set of network state information for environment reconstruction; and/or
iii. a representation of at least one metric associated with the at least one network functionality to be configured.

Step 1208 comprises determining, based on the output of executing the third AI/ML model, information for configuring the at least one network functionality.

Step 1210 comprises configuring, based on the information, the at least one network functionality.

In one example, the second set of network state information for environment reconstruction may comprise one or more information associated to the state dynamics of at least a functionality a network node or a radio cell. Non limiting examples may comprise information, measurements or predictions related to one or more of:
Mobility load balance, such as one or more of:
   a) radio resource status information (e.g., per radio cell, SBB coverage area, network slice)
   b) composite available capacity (e.g., per radio cell, SBB coverage area, network slice)
   c) Transport network load or capacity information (e.g., per radio cell, SBB coverage area, network slice)
   d) Number of active users (e.g., per radio cell, SBB coverage area, network slice)
   e) Number of users in RRC connected state (e.g., per radio cell, SBB coverage area, network slice)
   f) Number of users in RRC inactive state (e.g., per radio cell, SBB coverage area, network slice)
   g) Number of users supporting specific radio technologies (such as E-UTRAN, NG-RAN)
   h) An indication or a value of the mobility settings change parameters (e.g., per radio cell, SBB coverage area, network slice)
Random access procedures, such as one or more of:
   a) RACH resource configuration
   b) Statistical information related to RACH events, such as first and second statistical moments, or distribution function, of number of RACH events, number of successful RACH events, number of failed RACH events. For a given cell, such information may be provided as aggregate for all user devices, or filtered with respect to user devices (e.g., types of user devices) or source cell that generated a mobility event.
Handover procedure, such as one or more of:
   a) Statistical information, such as first and second statistical moments, or distribution function, of number of handover events. For a given cell, such information could be provided as an aggregate for the cell, or differentiated with respect to one or more neighboring cells.
   b) Frequency of handover of user devices to or from neighboring radio cells. For a given cell or SSB coverage area or network slice, this could be expressed as an aggregate information or with a granularity related to neighboring cells or neighboring SSB coverage area
   c) An indication and/or statistical information related to events or causes that triggered handover events.
Cell shaping, such as one or more of
   a) An indication or values of the cell shaping related parameters (e.g., per radio cell, SBB coverage area, network slice)’
   b) Frequency of cell shaping events
   c) Information related to events that triggered modification to cell shape
Coverage and capacity optimization, such as one or more of:
   a) An indication or values of the coverage and capacity related parameters (e.g., per radio cell, SBB coverage area, network slice)
   b) Frequency of coverage and capacity optimization events
   c) Information related to events that triggered modification to coverage and capacity optimization
energy saving, such as one or more of:
   a) An indication or values of the energy savings related parameters or configurations (e.g., per radio cell, SBB coverage area, network slice)
   b) Frequency of energy savings events configuration or reconfiguration
   c) Information related to events that triggered modification to energy savings parameters of configurations
downlink power control
   a) information related to configuration or reconfiguration of cell-specific parameters, such as
   b) control channel resources,
   c) semi-static uplink power control parameters
   d) TTD configuration,
   e) FDD configuration
   f) Discontinuous transmission DTX configuration
   g) Discontinuous reception DRX configurations
   h) Configuration of downlink reference signals (such as SSB, CSI-RS, discovery reference signals, etc.), such as one or more of
      i. An indication or values related to downlink reference signals Frequency of changes in configuration or reconfiguration downlink reference signals
      ii. Information related to events that triggered modification to configuration or reconfiguration of downlink reference signals
   i) Information related to and network slicing, including one or more of
      i. configuration information of network slices for at least one radio cell or network node
      ii. allocation of radio resources to network slices of at least one radio cell or network node
      iii. allocation information to subscribers of at least one network slice of a radio cell or network node.
      iv. Load or capacity information associated to at least a network slice of a network slice of a radio cell or a network node.

In one example, the second set of network state information for environment reconstruction may comprise one or more information associated to the state dynamics of at least a functionality a user device. Non limiting examples may comprise:
HARQ Related Information (e.g., a Sequence of ACK/NACK Values)
Buffer state information
Link adaptation parameters (or historical sequence thereof
Transmission power used for uplink or downlink transmission
One or more signal quality measurements, in uplink or downlink, such as RSRP, RSRQ, SNR, SINR
At least one channel state information (or a historical sequence thereof), such as channel quality indicator, rank, precoding indicator
One or more indicators of signal strength, such a propagation loss
An indication of successful or unsuccessful handover
An indication of the user speed, such as a measurement or a categorization (e.g., pedestrian, slow moving, fast moving, etc.)
An indication of the user position and/or orientation, and/or height
Network slicing related information.

In one example, the second set of network state information for environment reconstruction may comprise a combination of one or more information associated to the state dynamics of functionalities of any of: a network node, a radio cell and a user device.

### Embodiments Related to AI Models Design and Training

### AI Model Design and Types

In one embodiment, any of the first AI model the second AI model and the third AI model may be realized by one or more of:
A feedforward neural network
A convolutional neural network
A recurrent neural network
A transformer
A graph attention network
A generative pretrained transformer

In one embodiment:
The first AI model is realized by means of any of:
   a) A graph neural network
   b) A transformer
   c) A graph attention network
   d) A generative pretrained transformer
And the second AI model is part of a reinforcement learning algorithm based on any of:
   a) A feedforward neural network
   b) A convolutional neural network
   c) A recurrent neural network
      AI Model Training In one embodiment, the first network node or a third network node trains the first AI model and/or the second AI model.

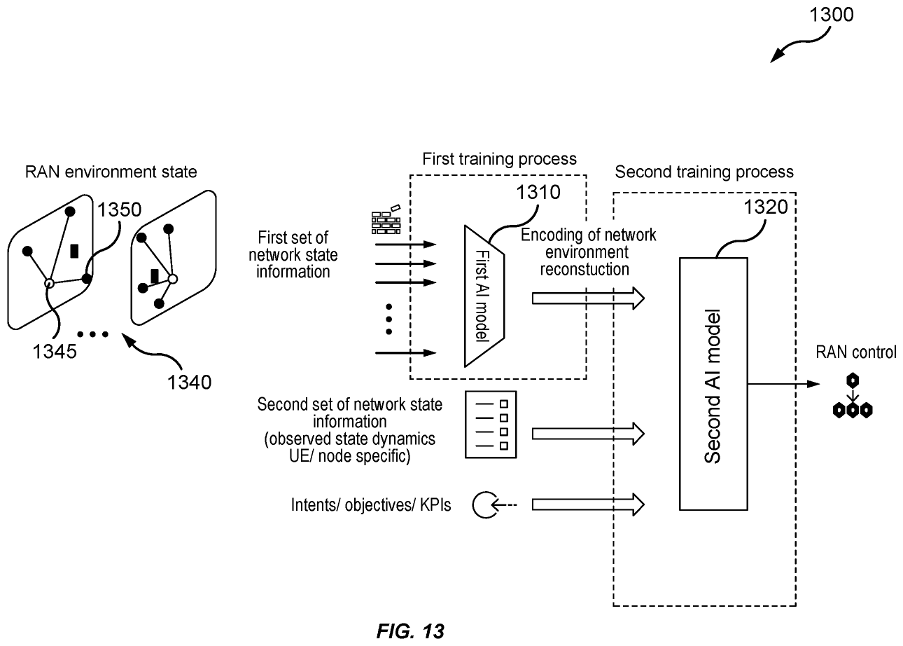

FIG. 13 is a block diagram of a communication network environment illustrating a method according to an embodiment. In one possible realization of the embodiment, the first network node or the third network node trains the first AI model 1310 and the second AI model 1320 separately, for instance based on separate training processes and different or separate training data sets, as illustrated in FIG. 13. FIG. 13 includes star graph 1340, in which the center node 1345 of the graph represents the serving cell, and the surrounding nodes 1350 represent the most relevant interfering cells.
In one example, the first AI model may be trained with a first training data set to determine an encoding of the network environment based on the first set of network state information, comprising static or semi-static information representing or characterizing the network deployment and topology, the network configuration (e.g., of network node, radio cells, user devices, etc.), and possibly the radio environment.
In one example, the second AI model may be trained with a second training data set determine parameters or instructions to optimize the network functionality based on static or semi-static information representing the network environment (such as the an encoding reconstructing the network environment, or the first set of network state information), together with dynamically changing information representing or characterizing a state associated to the network functionality to be optimized, and A representation of at least an intent, an objective, or a KPI that the network functionality is supposed to optimize or achieve

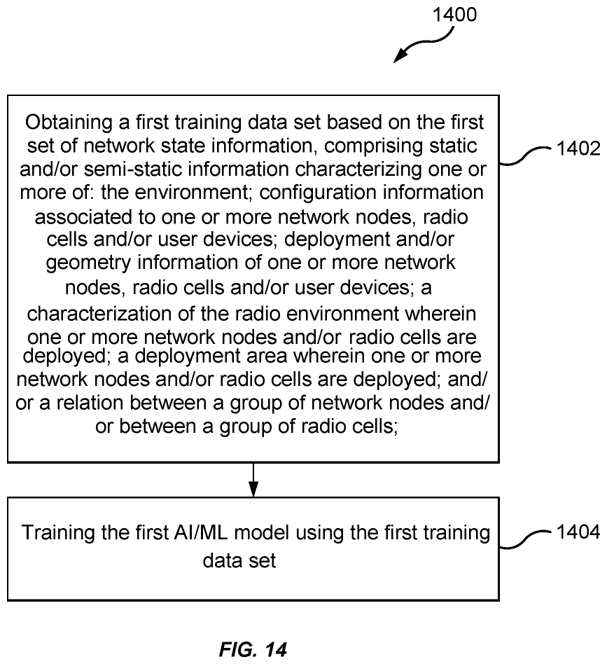

FIG. 14 is a flowchart illustrating a process 1400 according to an embodiment. Process 1400 is a computer-implemented method for training the AI/ML models disclosed herein. Process 1400 may begin with step 1402.

Step 1402 comprises obtaining a first training data set based on the first set of network state information, comprising static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells.

Step 1404 comprises training the first AI/ML model using the first training data set.

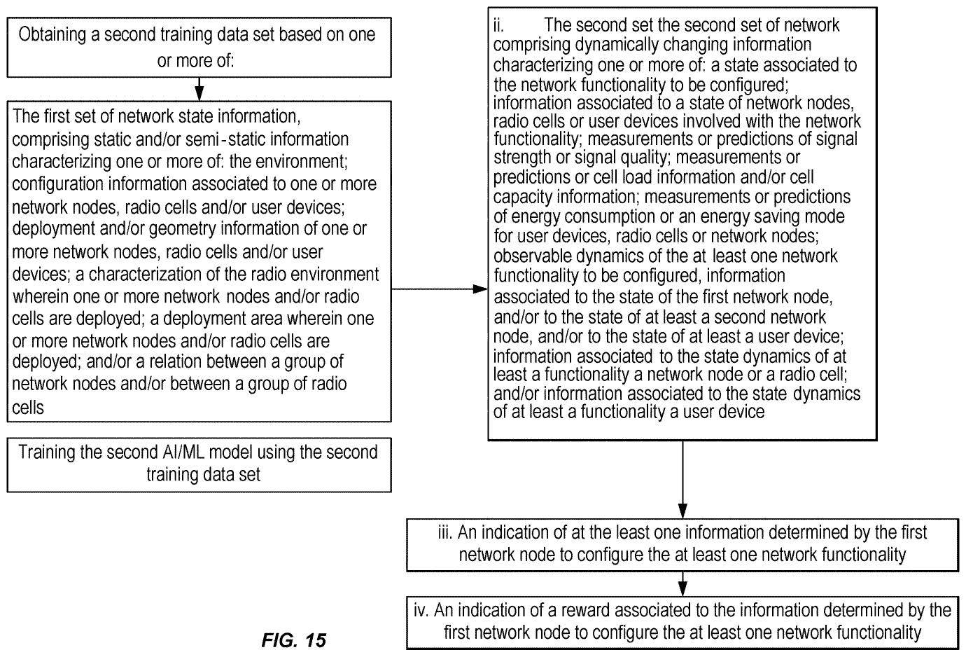

FIG. 15 is a flowchart illustrating a process 1500 according to an embodiment. Process 1500 is a computer-implemented method for training the AI/ML models disclosed herein. Process 1500 may begin with step 1502.

Step 1502 comprises obtaining a second training data set based on one or more of:
i. Step 1502a—the first set of network state information, comprising static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells;
ii. Step 1502b-the second set the second set of network comprising dynamically changing information characterizing one or more of: a state associated to the network functionality to be configured; information associated to a state of network nodes, radio cells or user devices involved with the network functionality; measurements or predictions of signal strength or signal quality; measurements or predictions or cell load information and/or cell capacity information; measurements or predictions of energy consumption or an energy saving mode for user devices, radio cells or network nodes; observable dynamics of the at least one network functionality to be configured, information associated to the state of the first network node, and/or to the state of at least a second network node, and/or to the state of at least a user device; information associated to the state dynamics of at least a functionality a network node or a radio cell; and/or information associated to the state dynamics of at least a functionality a user device;
iii. Step 1502c—an indication of at the least one information determined by the first network node to configure the at least one network functionality; and/or
iv. Step 1502d—an indication of a reward associated to the information determined by the first network node to configure the at least one network functionality.

Step 1504 comprises training the second AI/ML model using the second training data set.

FIG. 16 is a block diagram of a communication network environment illustrating a method according to an embodiment. In another possible realization of the embodiment, the first network node or the third AI model 1630 trains the first AI model 1610 and the second AI model 1620 jointly, for instance based on a single training processes, as illustrated in FIG. 16. In this case, the first AI model and the second AI model can be considered to be a single AI model composed by a cascade of two AI models.

### Description of Training Data Samples

In one embodiment, the first network node may additionally determine one or more training samples associated to one or more of
The first Al/ML model
The second AI/ML model
A third AI/ML model In one example, a training data sample may comprise one or more of:
The first set of network state information for environment reconstruction for optimizing the least one network functionality.
The second set of network state information for environment reconstruction for optimizing the least one network functionality.
An encoding reconstructing the environment where at least one functionality to be optimized is operating. Such encoding, in one example, may be provided by output of the first AI model
A representation of at least one intent, objective, or KPI—i.e., herein generally referred to as a metric—, associated to the at least one functionality of the communication network to be optimized.

In one embodiment where the third network node trains the first AI model and/or the second AI model and/or the third AI model, the first network node may additionally:
obtain any of the first AI model, the second AI model and the third AI model (or updated versions thereof) from the third network node.
provide one or more training data samples to the third network node, wherein the training data samples may be associated to any of the first AI model, the second AI model and the third Al model.

### Signaling Embodiments

### First Signaling Variant

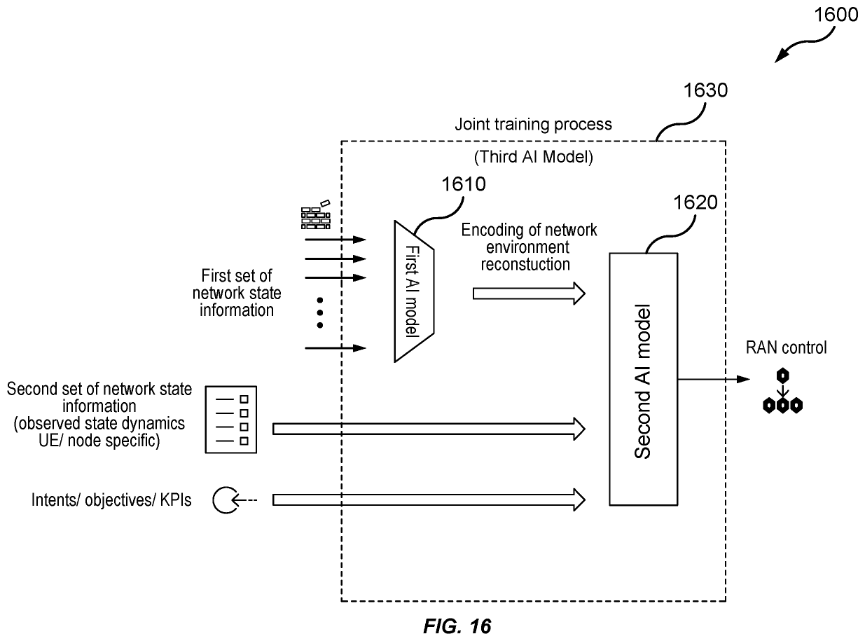

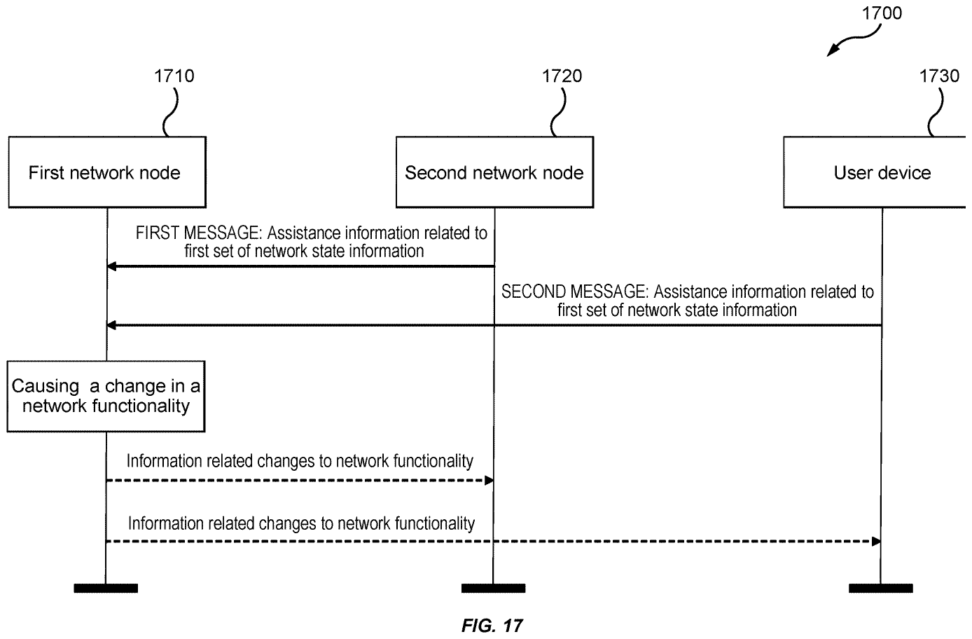

FIG. 17 illustrates a message flow diagram 1700 according to an embodiment. In one embodiment of the method, obtaining a first set of network state information for environment reconstruction for optimizing the least one network functionality may include obtaining information related to the first set of network state information from at least a second network node and/or from at least a user device.

In one possible realization of the embodiment, the first network node 1710 may obtain information related to the first set of network state information for environment reconstruction based on one or more steps of:
Receiving a FIRST MESSAGE from at least a second network node 1720, the FIRST MESSAGE comprising assistance information related the first set of network state information
Receiving a SECOND MESSAGE from at least a user device 1730, the SECOND MESSAGE comprising assistance information related the first set of network state information

The first network node may also obtain a first set of network state information for environment reconstruction for optimizing the least one network functionality by means of internal processes and measurements.

FIG. 17 shows a non-limiting example of the method. The network functionality to be optimized may be associated to the operations involving at least a network node and/or to operations involving a user device.

In one embodiment of the method, not illustrated in FIG. 17, the first network node may additionally transmit a request message to the at least one second network node and/or to at least one user device, the request message requesting to obtain assistance information related the first set of network state information. Therefore, in one realization of the embodiment, the first network node may receive the FIRST MESSAGE and/or the SECOND MESSAGE from the second network node and/or from the user device, respectively, in response to the request message.

In one embodiment of the method, the first network node may additionally
Transmitting to the second network node and/or to the user device information related to the determined change related to the least one network functionality

Such information may comprise parameter changes related to configuration and/or transmission formats related to the specific network functionality, in association to the first network node, or to the second network node, or to the user device.

### Embodiments related to FIRST MESSAGE

In one embodiment, assistance information related the first set of network state information for environment reconstruction received from a second network node with the FIRST MESSAGE may comprise one or more of:
An identifier of the second network node
A characterization of the deployment environment of the second network node, which may include one or more of
   a) Configuration information associated to the network node
   b) Deployment configuration, which may include one or more of
      i. An indication of the geographical location of the network node
      ii. An indication of the type of deployment area where the network node is located, such as rural, urban, dense urban, etc.
      iii. A 2D or a 3D map describing the location of the network node deployment and the surrounding area
      iv. A radio environmental map describing the signal strength or the signal attenuation in the area surrounding the network node.
A list of at least one antenna array configuration available at the second network node, comprising one or more information in the group of:
   a) An identifier of the antenna array
   b) The type of antenna array, such as MIMO, massive MIMO, etc.
   c) The type of beamforming supported
   d) The number of antenna elements supported
   e) The polarization configuration of the supported antenna elements
   f) The number of radio-frequency chains supported
   g) An indication of the height of at least one antenna array used by the second network node
   h) An indication of the orientation of the antenna array used by the second network node. In one example, the antenna array orientation may be expressed with respect to longitude and latitude spatial coordinates.
   i) An indication of the vertical tilt of the antenna array. The indicated antenna tilt could be a mechanical tilt, an electrical tilt or both
A list of one or more radio cells controlled by the second network node, e.g. a list of serving cells, wherein for each radio cell one or more of the following information is provided:
   a) Antenna array associated to the radio cell
   b) Orientation of the radio cell in the spatial domain. In one example this may be expressed in terms of orientation of the main radio lobe or orientation of the associated antenna array
   c) Serving cell information, such as those specified by the Served Cell Information E-UTRA and Served Cell Information NG-RAN information elements in the TS 38.423, v 17.4.0
   d) A characterization of the propagation environment within the radio cells, such as a statistical information related to signal attenuation (e.g., propagation loss) experienced by user devices. Such statistical information may additionally be filtered by type of user devices, type of transmission used to communicate with user devices, etc.
A characterization of the network deployment surrounding the second network node. In one example, the network deployment surrounding the second network node may comprise a list of one or more neighboring network nodes of the second network node comprising, for each neighboring network node, one or more information in the group of
   a) An identifier of the neighboring network node
   b) An indication of the geographical location of the neighboring network node, such as a set of coordinates specifying the location of the second network node (e.g., GPS coordinates)
   c) An indication of the type of deployment, e.g., rural, urban, dense urban, metropolitan, suburban, special event coverage, etc.
   d) A list of at least one antenna array configuration available at the neighboring network node, comprising one or more information in the group of:
      i. An identifier of the antenna array
      ii. The type of antenna array, such as MIMO, massive MIMO, etc.
      iii. The type of beamforming supported
      iv. The number of antenna elements supported
      v. The polarization configuration of the supported antenna elements
      vi. The number of radio-frequency chains supported
      vii. An indication of the height of at least one antenna array used by the second network node
      viii. An indication of the orientation of the antenna array used by the second network node. In one example, the antenna array orientation may be expressed with respect to longitude and latitude spatial coordinates.
      ix. An indication of the vertical tilt of the antenna array. The indicated antenna tilt could be a mechanical tilt, an electrical tilt or both
   e) A list of one or more radio cells controlled by the neighboring network node, e.g. a list of serving cells, wherein for each radio cell one or more of the following information is provided:
      i. Antenna array associated to the radio cell
      ii. Orientation of the radio cell in the spatial domain. In one example this may be expressed in terms of orientation of the main radio lobe or orientation of the associated antenna array
      iii. Serving cell information, such as those specified by the Served Cell Information E-UTRA and Served Cell Information NG-RAN information elements in the TS 38.423
      iv. A characterization of the propagation environment within the radio cells, such as a statistical information related to signal attenuation (e.g., propagation loss) experienced by user devices. Such statistical information may additionally be filtered by type of user devices, type of transmission used to communicate with user devices, etc.

In one embodiment, the FIRST MESSAGE may be realized by means of an extension of the XN SETUP procedure of the NG-RAN system, which is used by a network node to provide configuration information to a neighboring network node to establish an Xn connection. In another embodiment, the FIRST MESSAGE may be realized as an extension of the NG-RAN NODE CONFIGURATION UPDATE procedure, used by a network node to provide updated configuration information to a neighboring network node. In another example, the FIRST MESSAGE may be realized by means of an extension of the XN RESET procedure of the NG-RAN system.

In one embodiment, assistance information related the first set of network state information for environment reconstruction provided by the second network node may further consist of configuration information of the second network node, configuration information of at least a radio cell of the second network node, configuration information of neighboring network nodes of the second network node, configuration information of serving radio cells of neighboring network nodes of the second network node. In one example, such additional information may be provided by means of legacy procedure, such as the XN SETUP procedure, the XN RESET procedure or the NG-RAN NODE CONFIGURATION UPDATE procedure of the NG-RAN system or the NG-RAN NODE CONFIGURATION UPDATE procedure

### Embodiments Related to SECOND MESSAGE

In one embodiment, assistance information related the first set of network state information for environment reconstruction received form at least a user device with the SECOND MESSAGE comprises one or more of:
An identifier of the device
An indication of Antenna array configuration information including, for instance, one or more of
   a) An identifier of the antenna array
   b) The type of antenna array, such as MIMO, massive MIMO, etc.
   c) The type of beamforming supported
   d) The number of antenna elements supported
   e) The polarization configuration of the supported antenna elements
   f) The number of radio-frequency chains supported
   g) An indication of the height of at least one antenna array used by the second network node
   h) An indication of the orientation of the antenna array used by the second network node. In one example, the antenna array orientation may be expressed with respect to longitude and latitude spatial coordinates.
   i) An indication of the vertical tilt of the antenna array. The indicated antenna tilt could be a mechanical tilt, an electrical tilt or both
An indication of the user device manufacturer
An indication of the user device model
An indication of the user device software type and/or version
An indication of the user device battery level
An indication of the chipset type or chipset model
An indication of the user device context information, as defined for instance by the E-UTRAN or NG-RAN systems
A list of at least one neighboring radio cells relevant for user-centric environment reconstruction ·A list of reference signal beams of neighboring radio cells relevant for user-centric environment reconstruction, wherein reference signal beams may be indicated by at least one identifier and/or type of reference signal (e.g., CSI-RS signal, SSSB signal, etc.)
A list of radio signal measurements, associated to neighboring radio cells or reference signals thereof, relevant for user-centric environment reconstruction, such as reference signal received power, signal to noise ratio, signal to noise and interference ration, quality of experience, reference signal strength indicator, etc.

In one embodiment, the SECOND MESSAGE may be realized by means of RRC signaling procedures.

Second signaling variant: second set of network state information

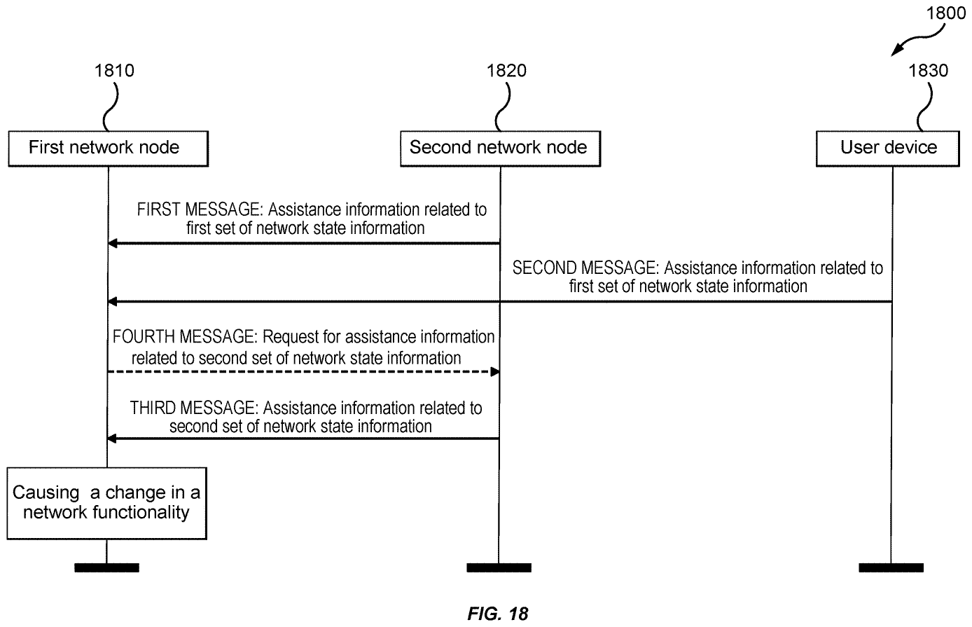

FIG. 18 illustrates a message flow diagram 1800 according to an embodiment. In one embodiment of the method, obtaining a second set of network state information for environment reconstruction for optimizing the least one network functionality may include obtaining information related to the second set of network state information from at least a second network node.

In one example, the first network node 1810 may obtain information related the second set of network state information for environment reconstruction based on:
Receiving a THIRD MESSAGE from at least the second network node 1820 comprising assistance information related to the second set of network state information for environment reconstruction for least one network functionality to be optimized by the first network node 1810

In this signaling variant, the network functionality may be associated to the operations of at least a network node, such as the first network node or the second network node. In one embodiment of this variant, the first network node may optionally transmit a FOURTH MESSAGE to the second network node, the FOURTH MESSAGE requesting one or more types of assistance information related to the second set of network state information to the second network node. In this case, the reception of assistance information related to the second set of network state information with the THIRD MESSAGE is conditioned to or triggered by or dependent on the transmission of the FOURTH MESSAGE.

FIG. 18 shows a non-limiting example of the first variant of the method

### Embodiments Related to THIRD MESSAGE

In one embodiment of the method, assistance information related to the second set of network state information carried by the THIRD MESSAGE may comprise one or more information, measurements or predictions related to
Mobility load balance, such as one or more of:
   a) radio resource status information (e.g., per radio cell, SBB coverage area, network slice)
   b) composite available capacity (e.g., per radio cell, SBB coverage area, network slice)
   c) Transport network load or capacity information (e.g., per radio cell, SBB coverage area, network slice)
   d) Number of active users (e.g., per radio cell, SBB coverage area, network slice)
   e) Number of users in RRC connected state (e.g., per radio cell, SBB coverage area, network slice)
   f) Number of users in RRC inactive state (e.g., per radio cell, SBB coverage area, network slice)
   g) Number of users supporting specific radio technologies (such as E-UTRAN, NG-RAN)
   h) An indication or a value of the mobility settings change parameters (e.g., per radio cell, SBB coverage area, network slice)
Random access procedures, such as one or more of:
   a) RACH resource configuration
   b) Statistical information related to RACH events, such as first and second statistical moments, or distribution function, of number of RACH events, number of successful RACH events, number of failed RACH events. For a given cell, such information may be provided as aggregate for all user devices, or filtered with respect to user devices (e.g., types of user devices) or source cell that generated a mobility event.
Handover procedure, such as one or more of:
   a) Statistical information, such as first and second statistical moments, or distribution function, of number of handover events. For a given cell, such information could be provided as an aggregate for the cell, or differentiated with respect to one or more neighboring cells.
   b) Frequency of handover of user devices to or from neighboring radio cells. For a given cell or SSB coverage area or network slice, this could be expressed as an aggregate information or with a granularity related to neighboring cells or neighboring SSB coverage area
   c) An indication and/or statistical information related to events or causes that triggered handover events.
Cell shaping, such as one or more of
   a) An indication or values of the cell shaping related parameters (e.g., per radio cell, SBB coverage area, network slice)′
   b) Frequency of cell shaping events
   c) Information related to events that triggered modification to cell shape
Coverage and capacity optimization, such as one or more of:
   a) An indication or values of the coverage and capacity related parameters (e.g., per radio cell, SBB coverage area, network slice)
   b) Frequency of coverage and capacity optimization events
   c) Information related to events that triggered modification to coverage and capacity optimization
energy saving, such as one or more of:
   a) An indication or values of the energy savings related parameters or configurations (e.g., per radio cell, SBB coverage area, network slice)
   b) Frequency of energy savings events configuration or reconfiguration
   c) Information related to events that triggered modification to energy savings parameters of configurations
downlink power control
information related to configuration or reconfiguration of cell-specific parameters, such as
   a) control channel resources,
   b) semi-static uplink power control parameters
   c) TTD configuration,
   d) FDD configuration
   e) Discontinuous transmission DTX configuration
   f) Discontinuous reception DRX configurations
   g) Configuration of downlink reference signals (such as SSB, CSI-RS, discovery reference signals, etc.), such as one or more of
      v. An indication or values related to downlink reference signals Frequency of changes in configuration or reconfiguration downlink reference signals
      vi. Information related to events that triggered modification to configuration or reconfiguration of downlink reference signals

In one embodiment, the THIRD MESSAGE carrying one or more specific assistance information related to the second set of network state information may be realized by means of standard defined procedures of extensions thereof. For example, the 3GPP NG-RAN and E-UTRAN system provide a RESOURCE STATUS REPORTING procedure over (over XN, F1, E1 interfaces, and X2 interface, respectively) to request and provide load information for mobility load balance. In a similar way, the dynamics of associated to a handover functionality may be derived by means of signaling involved in a HANDOVER procedure in combination to information associated to load balancing when handover is caused by load balancing.

Third Signaling Variant: State Information for Network Functionality from User Device

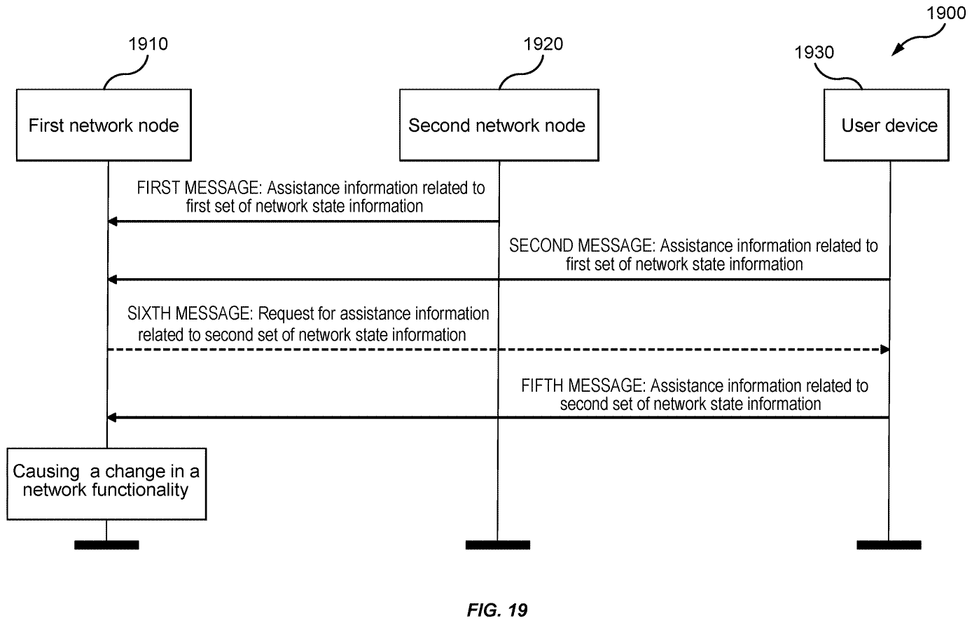

FIG. 19 illustrates a message flow diagram 1900 according to an embodiment. In one embodiment of the method, obtaining a second set of network state information for environment reconstruction for optimizing the least one network functionality may include obtaining information related to the second set of network state information from at least a user device.

In one example, the first network node 1910 may obtain information related the second set of network state information for environment reconstruction based on:
Receiving a FIFTH MESSAGE from at least a user device 1930, the FIFTH MESSAGE comprising assistance information related to the second set of network state information for environment reconstruction for at least one network functionality to be optimized by the first network node 1910

In this signaling variant, the network functionality may be associated to the operations of at least a user device, although in some cases such functionality may be executed by a network node, such as the first network node or the second network node.

In one embodiment of this variant, the first network node may optionally transmit a SIXTH MESSAGE to the user device, the SIXTH MESSAGE requesting one or more types of assistance information related to the second set of network state information to the user device. In this case, the reception of assistance information related to the second set of network state information with the FIFTH MESSAGE is conditioned to or triggered by or dependent on the transmission of the SIXTH MESSAGE.

FIG. 19 shows a non-limiting example of the first variant of the method.

In one exemplifying embodiment, the FIFTH MESSAGE received from at least a user device may include one or more information of:

In one example, the assistance information related to the second set of network state information for environment reconstruction may comprise one or more information associated to the state dynamics of at least a functionality a user device. Non limiting examples may comprise:
HARQ related information (e.g., a sequence of ACK/NACK values)
Buffer state information ·Link adaptation parameters (or historical sequence thereof
Transmission power used for uplink or downlink transmission
One or more signal quality measurements, in uplink or downlink, such as RSRP, RSRQ, SNR, SINR
least one channel state information (or a historical sequence thereof), such as channel quality indicator, rank, precoding indicator
One or more indicators of signal strength, such a propagation loss
An indication of successful or unsuccessful handover
An indication of the user speed, such as a measurement or a categorization (e.g., pedestrian, slow moving, fast moving, etc.)
An indication of the user position and/or orientation, and/or height
Information related to network slicing operations.

### Fourth Signaling Variant: Combination of all Variants

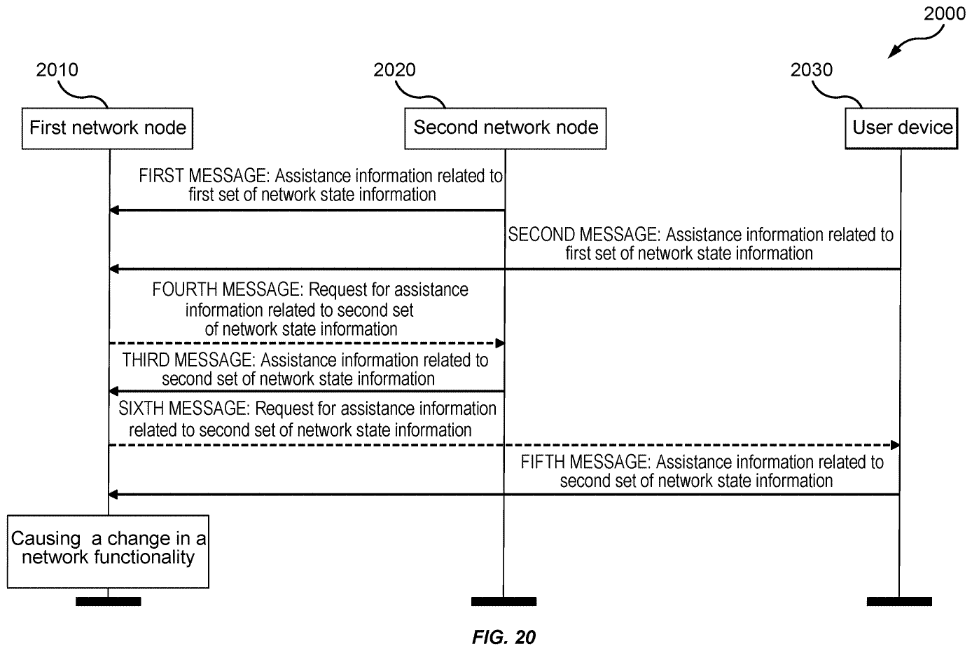

FIG. 20 illustrates a message flow diagram 2000 according to an embodiment. In a fourth signaling variant of the method, the first network node 2010 may:
obtaining a first set of network state information for environment reconstruction for optimizing the least one network functionality may include obtaining information related to the first set of network state information from at least a second network node 2020 and/or from at least a user device 2030; AND
obtaining a second set of network state information for environment reconstruction for optimizing the least one network functionality may include obtaining information related to the second set of network state information from at least a second network node 2020 and/or from at least a user device 2030.

FIG. 20 shows a non-limiting example of the fourth variant of the method.

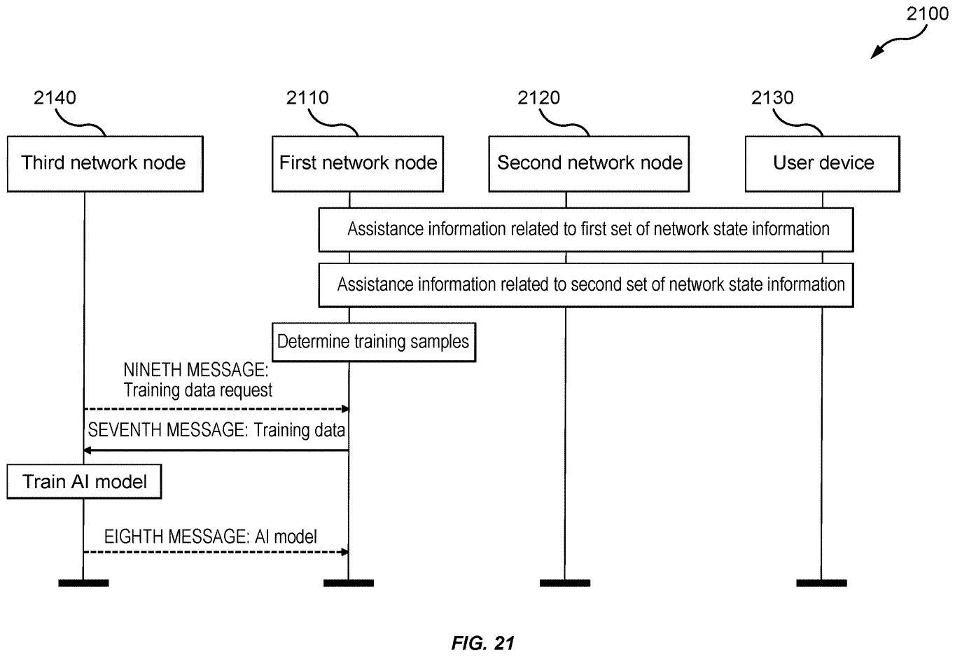

Fifth Signaling Variant: Training AI Models and Training Data Exchange po FIG. 21 illustrates a message flow diagram 2100 according to an embodiment. In one variant, the method executed by the first network node 2110 may include one or more steps of:
Obtaining at least one training data sample associated to one or more of:
   a) The first AI model
   b) The second AI model
   c) The third AI model representing the joint combination of the first AI model and the second AI model
Transmitting a SEVENTH MESSAGE to a third network node 2140, the SEVENTH MESSAGE comprising at least one training data sample associated to the first AI model, or the second Al model, or both.
Receiving from the third network node 2140 an EIGHTH MESSAGE, the EIGHTH MESSAGE comprising one of more of:
   a) The first AI model or an updated version of the first AI model
   b) The second AI model or an updated version of the second AI model
   c) A third AI model or an updated version of the third AI model, wherein the third AI model comprises a combination of the first AI model and the second AI model.

FIG. 21 shows a non-limiting example of this variant wherein the first network node provides training data to a third network node and, in return, receives an updated AI model. However, it should be noted that there is no sequential order between the transmission of the SEVENTH MESSAGE and the reception of the EIGHTH MESSAGE. In one embodiment of this variant of the method, the first network node may first receive EIGHTH MESSAGE from the third network node providing one or more AI models used by the first network node. In some examples, such AI models may have been trained with simulators and synthetic data. In this case, the first network node may then provide to the third network node training data samples derived from direct experience with the communication network environment by transmitting a SEVENTH MESSAGE.

In one embodiment of the method, the first network node may additionally
Receive an NINETH MESSAGE from the third network node, the NINETH MESSAGE requesting the first network node to provide one or more training data sample
   a) The first AI model
   b) The second AI model
   c) The third AI model representing the joint combination of the first AI model and the second AI model In this case, the first network node may obtain training data samples and/or transmit the NINTH MESSAGE based on the request received form the third network node.

In one variant of the method, the first AI model and the second AI model are trained jointly, that is, as a single AI model.

### Methods for a Second Network Node

The invention discloses a method executed by a second network node in a communication network, such as a radio access network (RAN), to generalize the design of at least one AI/ML model intended optimize at least one network functionality, the method comprising one or more of:
Transmitting a FIRST MESSAGE to a first network node, the FIRST MESSAGE comprising assistance information related the first set of network state information
Receive from the first network node a request message requesting to obtain assistance information related the first set of network state information
Receiving from the first network node information related to the determined change related to the least one network functionality

In some embodiments, the method of the second network node may further comprise one or more of:
Receive a FOURTH MESSAGE from the first network node, the FOURTH MESSAGE requesting one or more types of assistance information related to the second set of network state information to the second network node.
Transmit a THIRD MESSAGE to the first network node comprising assistance information related to the second set of network state information for environment reconstruction for least one network functionality to be optimized by the first network node.

### Methods for a Third Network Node

The invention discloses a method executed by a third network node in a communication network, such as a radio access network (RAN), to generalize the design of at least one AI/ML model intended optimize at least one network functionality, the method comprising one or more of:
Receiving a SEVENTH MESSAGE from the first network node, the SEVENTH MESSAGE comprising at least one training data sample associated to the first AI model, or the second Al model, or both.
Transmitting a Eighth Message to the First Network Node, the Eighth Message Comprising one of more of:
   a) The first AI model or an updated version of the first AI model
   b) The second AI model or an updated version of the second AI model
   c) A third AI model or an updated version of the third AI model, wherein the third AI model comprises a combination of the first AI model and the second AI model.

### Methods for User Device

The invention discloses a method executed by a user device in a communication network, such as a radio access network (RAN), the method comprising one or more of:
Transmitting a SECOND MESSAGE to a firs network node, the SECOND MESSAGE comprising assistance information related the first set of network state information
Receive from the first network node a request message requesting to obtain assistance information related the first set of network state information
Receiving from the first network node information related to the determined change related to the least one network functionality.

### Embodiments Related to Network Node Types and Architecture

Regarding possible scenarios of applicability of the methods:
the first network node and/or the second network node can be different RAN nodes (e.g. two gNBs, or two eNBs, or two en-gNBs, or two ng-eNBs)
the first network node and/or the second network node can be different nodes/functions of a same RAN node (e.g. a gNB-CU-CP and a gNB-DU, or a gNB-CU-CP and a gNB-CU-UP)
the first network node can be a RAN node (e.g. a gNBs, or a eNBs, or a en-gNBs, or a ng-eNBs) and the second network node can be component/nodes/functions of a second RAN node (e.g. gNB-CU-CP)
the first network node and/or the second network node can pertain to the same Radio Access Technology (e.g. e.g. E-UTRAN, NG-RAN, WiFi, etc.) or to different Radio Access Technologies (e.g. one to NR and the other to E-UTRAN or WiFi)
the first network node and/or the second network node can pertain to the same RAN system (e.g. E-UTRAN, NG-RAN, WiFi, etc) or to different RAN systems (e.g. one to NG-RAN and the other to E-UTRAN)
the first network node and the second network node may be connected via a direct signaling connection (e.g. two gNB via XnAP), or an indirect signaling connection (e.g. an e-NB and a gNB via S1AP, NGAP and one or more Core Network nodes, e.g. an MME and an AMF)
the first network node can be a management system, such as the OAM system or the SMO, while the second network node can consist of a RAN node or function.
The first network node can be a RAN node or function while the second network node can be a management system, such as the OAM or the SMO.
the first network node can be a core network node or function, such a 5GC function, while the second network node can consist of a RAN node or function.
The first network node can be a RAN node or function while the second network node can be a core network node or function, such a 5GC function

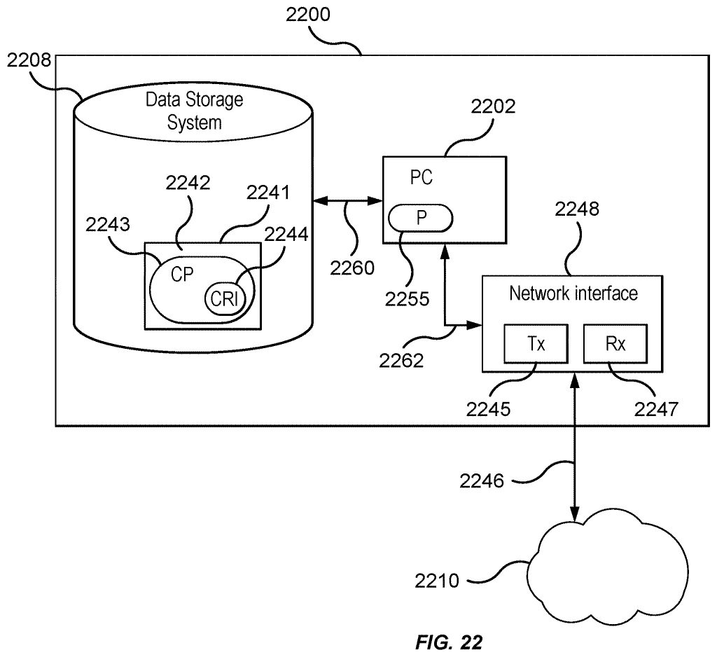

FIG. 22 is a block diagram of apparatus 1800 (e.g., an encoder or decoder), according to some embodiments, for performing the methods disclosed herein. As shown in FIG. 18, apparatus 1800 may comprise: processing circuitry (PC) 1802, which may include one or more processors (P) 1855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1800 may be a distributed computing apparatus); at least one network interface 1848 comprising a transmitter (Tx) 1845 and a receiver (Rx) 1847 for enabling apparatus 1800 to transmit data to and receive data from other nodes connected to a network 1810 (e.g., an Internet Protocol (IP) network) to which network interface 1848 is connected (directly or indirectly) (e.g., network interface 1848 may be wirelessly connected to the network 1810, in which case network interface 1848 is connected to an antenna arrangement); and a storage unit (a.k.a., “data storage system”) 1808, which may include one or more non-volatile storage devices and/or one or more volatile storage devices. Interface 1860 may connect PC 1802 and storage unit 1808, interface 1862 may connect PC 1802 and network interface 1848, and interface 1864 may connect network interface 1848 and network 1810. In embodiments where PC 1802 includes a programmable processor, a computer program product (CPP) 1141 may be provided. CPP 1841 includes a computer readable medium (CRM) 1842 storing a computer program (CP) 1843 comprising computer readable instructions (CRI) 1844. CRM 1842 may be a non-transitory computer readable medium, such as, magnetic media (e.g., a hard disk), optical media, memory devices (e.g., random access memory, flash memory), and the like. In some embodiments, the CRI 1844 of computer program 1143 is configured such that when executed by PC 1802, the CRI causes apparatus 1800 to perform steps described herein (e.g., steps described herein with reference to the flow charts). In other embodiments, apparatus 1800 may be configured to perform steps described herein without the need for code. That is, for example, PC 1802 may consist merely of one or more ASICs. Hence, the features of the embodiments described herein may be implemented in hardware and/or software.

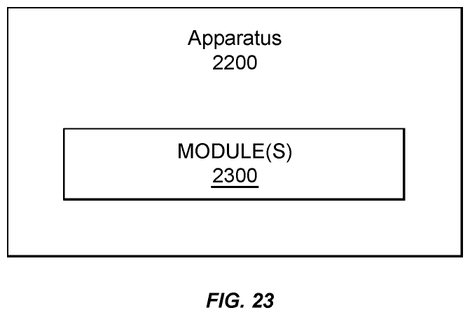

FIG. 23 is a block diagram of the apparatus 2200 according to some embodiments. The apparatus 2200 includes one or more modules 2300, each of which is implemented in software. The module(s) 2300 provide the functionality of apparatus 2200 described herein, for example, the functionality of one or more network nodes.

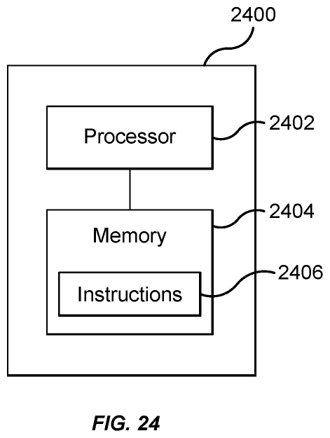

FIG. 24 is a block diagram of a node 2400 according to some embodiments. Generally, the node 2400 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, NodeBs, evolved NodeBs (eNBs) and NR NodeBs (gNBs)). Further examples of nodes include but are not limited to core network functions such as, for example, core network functions in a Fifth Generation Core network (5GC).

The node 2400 is configured (e.g. adapted, operative, or programmed) to perform any of the embodiments of the methods described herein. It will be appreciated that the node 2400 may comprise one or more virtual machines running different software and/or processes. The node 2400 may therefore comprise one or more servers, switches and/or storage devices and/or may comprise cloud computing infrastructure or infrastructure configured to perform in a distributed manner, that runs the software and/or processes.

The node 2400 may comprise a processor (e.g. processing circuitry or logic) 2402. The processor 2402 may control the operation of the node 2400 in the manner described herein. The processor 2402 can comprise one or more processors, processing units, multi-core processors or modules that are configured or programmed to control the node 2400 in the manner described herein. In particular implementations, the processor 2402 can comprise a plurality of software and/or hardware modules that are each configured to perform, or are for performing, individual or multiple steps of the functionality of the node 2400 as described herein.

The node 2400 may comprise a memory 2404. In some embodiments, the memory 2404 of the node 2400 can be configured to store program code or instructions 2406 that can be executed by the processor 2402 of the node 2400 to perform the functionality described herein. Alternatively or in addition, the memory 2404 of the node 2400, can be configured to store any requests, resources, information, data, signals, or similar that are described herein. The processor 2402 of the node 2400 may be configured to control the memory 2404 of the node 2400 to store any requests, resources, information, data, signals, or similar that are described herein.

It will be appreciated that the node 2400 may comprise other components in addition or alternatively to those indicated in FIG. 24. For example, in some embodiments, the node 2400 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 2402 of node 2400 may be configured to control such a communications interface to transmit to and/or receive from other nodes or network functions requests, resources, information, data, signals, or similar.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Concise Description of Certain Embodiments

### Group A Embodiments

1. A computer-implemented method (400), executed by a first network node in a communication network environment, for generalizing design of at least one artificial intelligence/machine learning (AI/ML) model for configuring at least one network functionality in the environment, comprising:
obtaining (402) a first set of network state information for reconstructing the environment to configure the at least one network functionality;
determining (404), based on a first AI/ML model, an encoding reconstructing the environment where the at least one network functionality to be configured is operating;
determining (406), based on the encoding reconstructing the environment where the at least one network functionality to be configured is operating, information for configuring the at least one network functionality; and causing (408), based on the information, a change to configure the at least one network functionality.

2. The method of embodiment A1, wherein input to the first AI/ML model includes the first set of network state information, the method further comprising: executing the first AI/ML model, wherein the output of executing the first AI/ML model includes the encoding reconstructing the environment.

3. The method of embodiments A1 or A2, wherein determining, based on the encoding reconstructing the environment where the at least one network functionality to be configured is operating, information for configuring the at least one network functionality, is further based on a representation of at least one metric associated with the at least one network functionality to be optimized.

4. The method of any of embodiments A1-A3, wherein causing, based on the information, a change to configure the at least one network functionality includes sending the information.

5. The method of any of embodiments A1-A4, wherein the information to configure the at least one network functionality includes one or more of parameters and/or instructions.

6. The method of any of embodiments A1-A5, wherein the first set of network state information includes static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells.

7. The method of any of embodiments A1-A6, wherein the first AI/ML model is designed such that the encoding reconstructing the network environment is associated to one of the first network node, a serving cell of the first network node, or a user device served by at least a serving cell of the first network node.

8. The method of any of embodiments A1-A7, wherein the at least one network functionality includes one or more of: network functionalities operating at different levels of the RAN protocol stack including from physical layer (PHY) to medium access control (MAC) layer, routing, transport, application layer, network configuration and deployment and core network operations; PHY layer functionalities, channel estimation, signal demodulation, and decoding; MAC layer functionalities, link adaptation, radio resource allocation, user scheduling over time and frequency resources, power control, and precoding; and/or functionalities acting on network configuration, mobility optimization, mobility load balancing, capacity and coverage optimization, energy saving configurations, cell shaping, network hyperparameters configuration, antenna tilt, control channel resources, semi-static uplink power control parameters, TTD configuration, FDD configuration, discontinuous transmission DTX configuration, discontinuous reception DRX configurations, configuration of downlink reference signals, and network slicing such as configuration of network slices and allocation of radio resources to network slices or subscribers thereof.

9. The method of any of embodiments A1-A8, wherein the first set of network state information and/or the encoding reconstructing the environment includes one of: network-node-centric state information and/or environment reconstruction; cell-centric state information and/or environment reconstruction; or user-centric state information and/or environment reconstruction.

10. The method of any of embodiments A1-A9, wherein the first set of network state information is represented in the form of a graph constructed as one of: a network-centric graph, a cell-centric graph, or a user-centric graph.

11. The method of any of embodiments A1-10, wherein determining, based on the encoding reconstructing the environment where the at least one network functionality to be configured is operating, information for configuring the at least one network functionality, is further based on a second AI/ML model, wherein input to the second AI/ML model includes one or more of the encoding reconstructing the environment where the at least one network functionality to be configured is operating, and/or a representation of at least one metric associated with the at least one network functionality to be configured, the method further comprising:
executing the second AI/ML model, wherein the output of executing the second AI/ML model includes the information for configuring the at least one network functionality.

12. The method of any of embodiments A1-A11, wherein the communication network environment includes one or more of: a radio access network (RAN) environment and/or an open radio access network (O-RAN) environment.

13. The method of any of embodiments A1-A12, wherein the first network node is one of: a RAN node, an OAM, a Core Network node, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, or a UE.

14. The method of any of embodiments A1-A13, wherein the first network node is configured as one of: a physical node, a function, or a logical entity.

15. The method of embodiment A14, wherein the first network node is configured as a logical entity and the logical entity is configured as a software entity.

16. The method of embodiments A14 or A15, wherein the first network node is configured as a logical entity and the logical entity is implemented in one of a data center or a cloud.

17. The method of any of embodiments A14-A16, wherein the first network node is configured as a logical entity and the logical entity is implemented using one or more virtual machines.

18. The method of any of embodiments A1-A17, further comprising: receiving, at the first network node, information characterizing a set of network nodes and/or radio cells surrounding a reference network node or radio cell that are related to and/or have an effect on the performance of the reference network node or radio cell.

19. The method of embodiment A3, wherein the at least one metric includes one or more of: an intent, objective, and/or key performance indicator (KPI).

20. The method of embodiment A3, wherein the representation of at least one metric associated with the at least one network functionality to be configured includes at least one metric associated to one of: a user device, a radio cell, or at least a network node.

21. A first network node (2400) in a communication network environment, for generalizing design of at least one artificial intelligence/machine learning (AI/ML) model for configuring at least one network functionality in the environment, the first node comprising:

one or more memories comprising instruction data representing a set of instructions; and
one or more processors (2402) configured to communicate with the one or more memories (2404) and to execute the set of instructions (2406), wherein the set of instructions, when executed by the processor, cause the processor to:
   obtain a first set of network state information for reconstructing the environment to configure the at least one network functionality;
determine, based on a first AI/ML model, an encoding reconstructing the environment where the at least one network functionality to be configured is operating;
determine, based on the encoding reconstructing the environment where the at least one network functionality to be configured is operating, information for configuring the at least one network functionality; and
cause, based on the information, a change to configure the at least one network functionality.

22. The first network node of embodiment A 21, wherein the set of instructions, when executed by the one or more processors, further cause the one or more processors to perform the method of any of embodiments A2 to A20.

23. A computer program (2243) comprising instructions (2244)which, when executed on at least one processor (2202), cause the at least one processor to carry out a method according to any of embodiments A1 to A20.

24. A carrier containing a computer program of embodiment A 23, wherein the carrier comprises one of an electronic signal, optical signal, radio signal or computer readable storage medium.

25. A computer program product (2241) comprising non transitory computer readable media (2242) having stored thereon a computer program (2243) of embodiment A24.

26. A computer-implemented method (600), executed by a first network node in a communication network environment, for generalizing design of at least one artificial intelligence/machine learning (AI/ML) model for configuring at least one network functionality in the environment, comprising:
obtaining (602) a first set of network state information for reconstructing the environment to configure the at least one network functionality;
executing (604) a third AI/ML model, wherein input to the third AI/ML model includes the first set of network state information for environment reconstruction and a representation of at least one metric associated with the at least one network functionality to be configured;
determining (606), based on the output of executing the third AI/ML model, information for configuring the at least one network functionality; and
causing (608), based on the information, a change to configure the at least one network functionality.

### Group B Embodiments

1. A computer-implemented method (900), executed by a first network node in a communication network environment, for generalizing design of at least one artificial intelligence/machine learning (AI/ML) model for configuring at least one network functionality in the environment, comprising:
obtaining (902) a first set of network state information for reconstructing the environment to configure the at least one network functionality;
determining (904), based on a first AI/ML model, an encoding reconstructing the environment where the at least one network functionality to be configured is operating;
obtaining (906) a second set of network state information for reconstructing the environment to configure the at least one network functionality;
determining (908) information for configuring the at least one network functionality based on one or more of:
   i. the encoding reconstructing the environment where the at least one network functionality to be configured is operating;
   ii. the second set of network state information for environment reconstruction; and/or a representation of at least one metric associated with the at least one network functionality to be optimized; and
causing (910), based on the information, a change to configure the at least one network functionality.

2. The method of embodiment B1, wherein input to the first AI/ML model includes the first set of network state information, the method further comprising:

executing the first AI/ML model, wherein the output of executing the first AI/ML model includes the encoding reconstructing the environment.

3. The method of embodiments B1 or B2, wherein causing, based on the information, a change to configure the at least one network functionality, includes sending the information.

4. The method of any of embodiments B1-B3, wherein the information to configure the at least one network functionality includes one or more of parameters and/or instructions.

5. The method of any of embodiments B1-B4, wherein the first set of network state information includes static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells.

6. The method of any of embodiments B1-B5, wherein determining information for configuring the at least one network functionality is further based on a second AI/ML model, wherein input to the second AI/ML model includes one or more of:
i. the encoding reconstructing the environment where the at least one network functionality to be configured is operating;
ii. the second set of network state information for environment reconstruction; and/or
iii. a representation of at least one metric associated with the at least one network functionality to be optimized; and
   the method further comprising executing the second AI/ML model, wherein the output of executing the second AI/ML model includes the information for configuring the at least one network functionality. 7. The method of embodiment B6, wherein the second set of network state information includes dynamically changing information characterizing one or more of: a state associated to the network functionality to be configured; information associated to a state of network nodes, radio cells or user devices involved with the network functionality; measurements or predictions of signal strength or signal quality; measurements or predictions or cell load information and/or cell capacity information; measurements or predictions of energy consumption or an energy saving mode for user devices, radio cells or network nodes; observable dynamics of the at least one network functionality to be configured, information associated to the state of the first network node, and/or to the state of at least a second network node, and/or to the state of at least a user device; information associated to the state dynamics of at least a functionality a network node or a radio cell; and/or information associated to the state dynamics of at least a functionality a user device.

8. A first network node (2400) in a communication network environment, for generalizing design of at least one artificial intelligence/machine learning (AI/ML) model for configuring at least one network functionality in the environment, the first node comprising:
one or more memories comprising instruction data representing a set of instructions; and one or more processors (2402) configured to communicate with the one or more memories (2404) and to execute the set of instructions (2406), wherein the set of instructions, when executed by the processor, cause the processor to:
obtain a First Set of Network State Information for Reconstructing the Environment to Configure the at Least one network functionality;
determine, based on a first AI/ML model, an encoding reconstructing the environment where the at least one network functionality to be configured is operating;
obtain a second set of network state information for reconstructing the environment to configure the at least one network functionality;
   determine information for configuring the at least one network functionality based on one or more of:
   i. the encoding reconstructing the environment where the at least one network functionality to be configured is operating;
   ii. the second set of network state information for environment reconstruction; and/or
   iii. a representation of at least one metric associated with the at least one network functionality to be optimized; and
      cause, based on the information, a change to configure the at least one network functionality.

9. The first network node of embodiment B8, wherein the set of instructions, when executed by the one or more processors, further cause the one or more processors to perform the method of any of embodiments B2 to B7.

10. A computer program (2243) comprising instructions (2244) which, when executed on at least one processor (2402), cause the at least one processor to carry out a method according to any of embodiments B1 to B7.

11. A carrier containing a computer program of embodiment B10, wherein the carrier comprises one of an electronic signal, optical signal, radio signal or computer readable storage medium.

12. A computer program product (2241) comprising non transitory computer readable media (2242) having stored thereon a computer program (2243) of embodiment B10.

13. A computer-implemented method (1100), executed by a first network node in a communication network environment, for generalizing design of at least one artificial intelligence/machine learning (AI/ML) model for configuring at least one network functionality in the environment, comprising:
obtaining (1102) a first set of network state information for reconstructing the environment to configure the at least one network functionality;
determining (1104), based on a first AI/ML model, an encoding reconstructing the environment where the at least one network functionality to be configured is operating;
obtaining (1106) a second set of network state information for reconstructing the environment to configure the at least one network functionality;
determining (1108) information for configuring the at least one network functionality based on one or more of:
   i. the encoding reconstructing the environment where the at least one network functionality to be configured is operating;
   ii. first set of network state information for environment reconstruction;
   iii. the second set of network state information for environment reconstruction; and/or
   iv. a representation of at least one metric associated with the at least one network functionality to be optimized; and
causing (1110), based on the information, a change to configure the at least one network functionality.

14. A computer-implemented method (1200), executed by a first network node in a communication network environment, for generalizing design of at least one artificial intelligence/machine learning (AI/ML) model for configuring at least one network functionality in the environment, comprising:
obtaining (1202) a first set of network state information for reconstructing the environment to configure the at least one network functionality;
obtaining (1204) a second set of network state information for reconstructing the environment to configure the at least one network functionality;
executing (1206) a third AI/ML model, wherein input to the third AI/ML model includes one or more of:
   i. the first set of network state information for environment reconstruction;
   ii. the second set of network state information for environment reconstruction; and/or
   iii. a representation of at least one metric associated with the at least one network functionality to be configured;
determining (1208), based on the output of executing the third AI/ML model, information for configuring the at least one network functionality; and
causing (1210), based on the information, a change to configure the at least one network functionality.

### Group C Embodiments

1. The method of any of the preceding Group A and B embodiments, wherein the first AI/ML model and/or the second AI ML model are part of an AI/ML process in the group of: supervised learning process, a deep learning process, a reinforcement learning process, a contextual multi-armed bandit process, an autoregression process, and/or combinations thereof.

2. The method of any of the preceding Group A and B embodiments, wherein the first AI/ML model and/or the second AI ML model are part of a reinforcement learning process and the reinforcement learning process used is one of: a deep reinforcement learning process, an actor-critic process, a policy gradient process, or an off-policy reinforcement learning process, an offline reinforcement learning process.

3. The method of any of the preceding Group A and B embodiments, wherein the first AI/ML model and/or the second AI/ML model are one of: a feedforward neural network, a deep neural network, a recurrent neural network, a convolutional neural network, a graph neural network, a graph attention network, a transformer, and/or a generative pretrained transformer.

4. The method of any of the preceding Group A and B embodiments, wherein the first AI/ML model is one of: a graph neural network, a graph attention network, a transformer or a generative pretrained transformer; and the second AI/ML model is part of a reinforcement learning process.

### Group D Embodiments

1. The computer-implemented methods of any of the preceding Groups A to C embodiments, further comprising:
obtaining (1402) a first training data set based on the first set of network state information, comprising static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells; and
training (1404) the first AI/ML model using the first training data set.

2. the Computer-implemented Methods of Any of the Preceding Groups a to C Embodiments, Further comprising:
obtaining (1502) a second training data set based on one or more of:
   i. (1502a) the first set of network state information, comprising static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells;
   (1502b) the second set the second set of network comprising dynamically changing information characterizing one or more of: a state associated to the network functionality to be configured; information associated to a state of network nodes, radio cells or user devices involved with the network functionality; measurements or predictions of signal strength or signal quality; measurements or predictions or cell load information and/or cell capacity information; measurements or predictions of energy consumption or an energy saving mode for user devices, radio cells or network nodes; observable dynamics of the at least one network functionality to be configured, information associated to the state of the first network node, and/or to the state of at least a second network node, and/or to the state of at least a user device; information associated to the state dynamics of at least a functionality a network node or a radio cell; and/or information associated to the state dynamics of at least a functionality a user device;
   (1502c) an indication of at the least one information determined by the first network node to configure the at least one network functionality; and/or
   iv. (1502d) an indication of a reward associated to the information determined by the first network node to configure the at least one network functionality; and
training (1504) the second AI/ML model using the second training data set.

3. The computer-implemented methods of any of the preceding Groups A to C embodiments, further comprising:
a third AI/ML model, wherein the third AI/ML model is based on the union of the first AI/ML model and the second AI/ML.

4. The computer-implemented methods of any of the preceding embodiments, further comprising: the first network node determining one or more training data sets for training one or more of: the first AI/ML model, the second AI/ML model, and/or the third AI/ML model; and wherein the one or more training data sets includes one or more of:
i. the first set of network state information, comprising static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells;
ii. the second set the second set of network comprising dynamically changing information characterizing one or more of: a state associated to the network functionality to be configured; information associated to a state of network nodes, radio cells or user devices involved with the network functionality; measurements or predictions of signal strength or signal quality; measurements or predictions or cell load information and/or cell capacity information; measurements or predictions of energy consumption or an energy saving mode for user devices, radio cells or network nodes; observable dynamics of the at least one network functionality to be configured, information associated to the state of the first network node, and/or to the state of at least a second network node, and/or to the state of at least a user device; information associated to the state dynamics of at least a functionality a network node or a radio cell; and/or information associated to the state dynamics of at least a functionality a user device;
iii. an encoding reconstructing the environment where the at least one network functionality to be configured is operating;
iv. a representation of at least one metric associated with the at least one network functionality to be optimized;
v. an indication of at the least one information determined by the first network node to configure the at least one network functionality; and/or
vi. an indication of a reward associated to the information determined by the first network node to configure the at least one network functionality.

### Group E Embodiments

1. The computer-implemented methods of any of the preceding Group A embodiments, wherein obtaining a first set of network state information for reconstructing the environment to configure the at least one network functionality includes one or more of:
i. obtaining information related to the first set of network state information from at least a second network node and/or from at least a user device;
ii. obtaining information related to the first set of network state information for environment reconstruction based on one or more of:
   a. receiving a FIRST MESSAGE from at least a second network node, the FIRST MESSAGE comprising assistance information related the first set of network state information; and/or
   b. receiving a SECOND MESSAGE from at least a user device, the SECOND MESSAGE comprising assistance information related the first set of network state information;
iii. obtaining a first set of network state information for environment reconstruction for configuring the least one network functionality by internal processes and measurements.

2. The computer-implemented methods of any of the preceding Group A embodiments, wherein obtaining a first set of network state information for reconstructing the environment to configure the at least one network functionality includes one or more of:
i. transmitting a request message to at least one second network node and/or to at least one user device, the request message requesting to obtain assistance information related the first set of network state information, and receiving a FIRST MESSAGE and/or the SECOND MESSAGE from the second network node and/or from the user device in response to the request message; and/or
transmitting to a second network node and/or to a user device information related to the determined information for configuring the at least one network functionality.

3. The computer-implemented methods of any of the preceding Group B embodiments, wherein obtaining a second set of network state information for reconstructing the environment to configure the at least one network functionality includes one or more of:
i. obtaining information related to the second set of network state information from at least a second network node; and/or
ii. obtaining information related the second set of network state information for environment reconstruction based on one or more of:
   a. receiving a THIRD MESSAGE from at least the second network node comprising assistance information related to the second set of network state information for environment reconstruction for least one network functionality to be configured by the first network node;
   b. transmitting a FOURTH MESSAGE to a second network node, the FOURTH MESSAGE requesting one or more types of assistance information related to the second set of network state information to the second network node; and/or
   c. receiving the assistance information related to the second set of network state information with the THIRD MESSAGE, conditioned to or triggered by or dependent on the transmission of the FOURTH MESSAGE.

4. The computer-implemented methods of any of the preceding Group B embodiments, wherein obtaining a second set of network state information for reconstructing the environment to configure the at least one network functionality includes one or more of:
i. obtaining information related to the second set of network state information from at least a user device; and/or
ii. obtaining information related the second set of network state information for environment reconstruction based on one or more of:
   a. receiving a FIFTH MESSAGE from at least a user device, the FIFTH MESSAGE comprising assistance information related to the second set of network state information for environment reconstruction for at least one network functionality to be configured by the first network node;
b. transmitting a SIXTH MESSAGE to the user device, the SIXTH MESSAGE requesting one or more types of assistance information related to the second set of network state information to the user device; and/or
   c. receiving the assistance information related to the second set of network state information with the FIFTH MESSAGE, conditioned to or triggered by or dependent on the transmission of the SIXTH MESSAGE.

5. The computer-implemented methods of any of the preceding Group A and B embodiments,
wherein obtaining a first set of network state information for reconstructing the environment to configure the at least one network functionality includes obtaining information related to the first set of network state information from at least a second network node and/or from at least a user device; and
wherein obtaining a second set of network state information for reconstructing the environment to configure the at least one network functionality includes obtaining information related to the second set of network state information from at least a second network node and/or from at least a user device.

6. The computer-implemented methods of any of the preceding Group C and D embodiments, wherein obtaining a first training data set and/or a second training data set associated to one or more of the first AI/ML model, the second AI/ML model and/or the third AI/ML model includes one or more of:
i. transmitting a SEVENTH MESSAGE to a third network node, the SEVENTH MESSAGE comprising at least one training data set associated to the first AI/ML model, or the second AI/ML model, or both;
receiving From the Third Network Node an Eighth Message, the Eighth Message comprising one of more of:
   a. the first AI/ML model or an updated version of the first AI/ML model;
   b. the second AI/ML model or an updated version of the second AI/ML model; and/or
   c. the third AI/ML model or an updated version of the third AI/ML model, wherein the third AI model comprises a combination of the first AI/ML model and the second AI/ML model; and/or
iii. receiving a NINETH MESSAGE from the third network node, the NINETH MESSAGE requesting the first network node to provide one or more training data sets comprising one of more of:
   a. the First Ai/ml Model;
   b. the Second Ai/ml Model; And/or
   c. the third AI/ML model representing the joint combination of the first AI/ML model and the second AI/ML model.

### Group F Embodiments

1. The computer-implemented methods of any of the preceding Groups A to E embodiments, wherein the first set of network state information for reconstructing the environment to configure the at least one network functionality includes one or more of:
i. an identifier of a reference network node and/or radio cell and/or user device for environment reconstruction;
ii. a list of at least one neighboring network node of a reference network node or a reference radio cell or a reference user;
iii. for each neighboring network node, state information for environment reconstruction further comprising one or more of:
   a. configuration information associated to the network node;
   b. deployment configuration, further comprising one or more of:
      i. an indication of the geographical location of the network node;
c. an indication of the type of deployment area where the network node is located;
c. a 2D or a 3D map describing the location of the network node deployment and the surrounding area; and/or
e. a radio environmental map describing the signal strength or the signal attenuation in the area surrounding the network node;
iv. a list of at least one neighboring radio cell of the reference network node or the reference radio cell or the reference user; and/or
v. for each neighboring radio cell, state information for environment reconstruction further comprising one or more of:
   a. TDD or FDD configuration information;
   b. uplink power control hyperparameters for open loop power control;
   c. measurement timing configuration;
   d. antenna array configuration information, including one or more of:
      i. an identifier of the antenna array;
      ii. a type of antenna array;
      iii. a type of beamforming supported;
      iv. a number of antenna elements supported;
      v. a polarization configuration of the supported antenna elements;
      vi. a number of radio-frequency chains supported;
      vii. an indication of the height of at least one antenna array used by the second network node;
      viii. an indication of the orientation of the antenna array used by the second network node; and/or
      ix. an Indication of the Vertical Tilt of the Antenna Array.

2. The computer-implemented methods of any of the preceding Groups A to E embodiments, wherein the first set of network state information for reconstructing the environment to configure the at least one network functionality includes one or more of:
i. an identifier of a reference user device for environment reconstruction
ii. an indication of antenna array configuration information, including one or more of:
   a. an identifier of the antenna array;
   b. a type of antenna array;
   c. a type of beamforming supported;
   d. a number of antenna elements supported;
   e. a polarization configuration of the supported antenna elements;
   f. a number of radio-frequency chains supported;
   g. an indication of the height of at least one antenna array used by the second network node;
   h. an indication of the orientation of the antenna array used by the second network node; and/or
   i. an indication of the vertical tilt of the antenna array;
iii. an indication of the user device manufacturer;
iv. an indication of the user device model;
v. an indication of the user device software type and/or version;
vi. an indication of the user device battery level;
vii. an indication of the chipset type or chipset model;
viii. an indication of the user device context information;
ix. a list of at least one neighboring radio cells relevant for user-centric environment reconstruction;
x. a list of reference signal beams of neighboring radio cells relevant for user-centric environment reconstruction, wherein reference signal beams are indicated by at least one identifier and/or type of reference signal; and/or
xi. a list of radio signal measurements, associated to neighboring radio cells or reference signals thereof, relevant for user-centric environment reconstruction, including one or more of: reference signal received power, signal to noise ratio, signal to noise and interference ratio, quality of experience, and/or reference signal strength indicator.

3. The computer-implemented methods of any of the preceding Groups A to E embodiments, wherein the second set of network state information for reconstructing the environment to configure the at least one network functionality includes one or more of:
i. information associated to the state dynamics of at least a functionality of a network node or a radio cell;
ii. information, measurements and/or predictions related to one or more of:
   a. mobility load balance, including one or more of:
      i. radio resource status information;
      ii. composite available capacity;
      iii. transport network load or capacity information;
      iv. number of active users;
      v. number of users in RRC connected state;
      vi. number of users in RRC inactive state;
      vii. number of users supporting specific radio technologies; and/or
viii. an indication or a value of the mobility settings change parameters;
iii. random access procedures, including one or more of:
   a. RACH resource configuration;
   b. statistical information related to RACH events, including one or more of:
      i. first and second statistical moments;
      ii. distribution function of one or more of:
         1. number of RACH events;
         2. number of successful RACH events; and/or
         3. number of failed RACH events;
iv. handover procedure, including one or more of:
   a. statistical information, including one or more of:
      i. first and second statistical moments; and/or
      ii. distribution function of number of handover events;
   b. frequency of handover of user devices to or from neighboring radio cells;
   c. an indication and/or statistical information related to events or causes that triggered handover events;
v. cell shaping, including one or more of:
   a. an indication or values of the cell shaping related parameters;
   b. frequency of cell shaping events; and/or
c. information related to events that triggered modification to cell shape;
vi. coverage and/or capacity optimization, including one or more of:
   a. an indication and/or values of the coverage and capacity related parameters;
b. frequency of coverage and/or capacity optimization events; and/or
c. information related to events that triggered modification to coverage and/or capacity optimization;
vii. energy saving, including one or more of:
   a. an indication or values of the energy savings related parameters or configurations;
   b. frequency of energy savings events configuration or reconfiguration; and/or
   c. information related to events that triggered modification to energy savings parameters of configurations;
viii. downlink power control; and/or
ix. information related to configuration or reconfiguration of cell-specific parameters, including one or more of:
   a. control channel resources;
   b. semi-static uplink power control parameters;
   c. TTD configuration;
   d. FDD configuration;
   e. Discontinuous transmission DTX configuration;
   f. Discontinuous reception DRX configurations; and/or
   g. configuration of downlink reference signals, including one or more of:
      i. an indication or values related to downlink reference signals and/or frequency of changes in configuration or reconfiguration of downlink reference signals; and/or
      ii. information related to events that triggered modification to configuration or reconfiguration of downlink reference signals; and/or
x. information related to and network slicing, including one or more of
   a. configuration information of network slices for at least one radio cell or network node
   b. allocation of radio resources to network slices of at least one radio cell or network node
   c. allocation information to subscribers of at least one network slice of a radio cell or network node.
   d. Load or capacity information associated to at least a network slice of a network slice of a radio cell or a network node

4. The computer-implemented methods of any of the preceding Groups A to E embodiments, wherein the second set of network state information for reconstructing the environment to configure the at least one network functionality includes one or more of:
i. information associated to the state dynamics of at least a functionality a user device;
ii. HARQ related information;
iii. buffer state information;
iv. link adaptation parameters;
v. transmission power used for uplink or downlink transmission;
vi. one or more signal quality measurements, in uplink or downlink;
vii. at least one channel state information;
viii. one or more indicators of signal strength;
ix an indication of successful or unsuccessful handover;
x. an indication of user speed; and/or
xi. an indication of the user position and/or orientation, and/or height
xii. network slicing related information.

5. The computer-implemented methods of any of the preceding Groups A to E embodiments, wherein the second set of network state information for reconstructing the environment to configure the at least one network functionality includes a combination of one or more information associated to the state dynamics of functionalities of any of: a network node, a radio cell and a user device.

### Group G Embodiments

1. A node (2400) in a communication network environment, for generalizing design of at least one artificial intelligence/machine learning (AI/ML) model for configuring at least one network functionality in the environment, the node comprising:
one or more memories (2404) comprising instruction data representing a set of instructions (2406); and
one or more processors (2402) configured to communicate with the one or more memories and to execute the set of instructions, wherein the set of instructions, when executed by the processor, cause the one or more processors to perform the methods of any one of the preceding Groups A to F embodiments.

2. A computer program (2243) comprising instructions (2244) which, when executed by processing circuitry (2202), causes the processing circuitry to carry out he methods of any one of the preceding Groups A to F embodiments.

3. A carrier containing a computer program according to embodiment G2, wherein the carrier comprises one of an electronic signals, optical signal, radio signal or computer readable storage medium.

4. A computer program product (2241) comprising a non-transitory computer readable medium (2242) having stored thereon a computer program (2243) according to embodiment G2.

5. an Apparatus (2200), the Apparatus Comprising: a memory (2242); and
processing circuitry (2202) coupled to the memory, wherein the apparatus is configured to perform the methods of any one of the preceding Groups A to F embodiments.

While various embodiments are described herein, it should be understood that they have been presented by way of example only, and not limitation. Thus, the breadth and scope of this disclosure should not be limited by any of the above described exemplary embodiments. Moreover, any combination of the above-described embodiments in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method executed by a first network node in a communication network environment, for generalizing design of at least one artificial intelligence/machine learning (AI/ML) model for configuring at least one network functionality in the environment, comprising:
obtaining a first set of network state information for reconstructing the environment to configure the at least one network functionality;
determining, based on a first AI/ML model, an encoding reconstructing the environment where the at least one network functionality to be configured is operating, wherein input to the first AI/ML model includes the first set of network state information;
executing the first AI/ML model, wherein the output of executing the first AI/ML model includes the encoding reconstructing the environment;
obtaining a second set of network state information for reconstructing the environment to configure the at least one network functionality;
determining information for configuring the at least one network functionality based on one or more of:
i. the encoding reconstructing the environment where the at least one network functionality to be configured is operating;
ii. the second set of network state information for environment reconstruction; and/or
iii. a representation of at least one metric associated with the at least one network functionality to be optimized; and
configuring, based on the information, the at least one network functionality.

2. The method according to claim 1, wherein configuring, based on the information, the at least one network functionality, includes sending the information.

3. The method according to claim 1, wherein the information for configuring the at least one network functionality includes one or more of parameters and/or instructions.

4. The method according to claim 1, wherein the first set of network state information includes static and/or semi-static information characterizing one or more of: the environment; configuration information associated to one or more network nodes, radio cells (or partitions thereof) and/or user devices; deployment and/or geometry information of one or more network nodes, radio cells and/or user devices; a characterization of the radio environment wherein one or more network nodes and/or radio cells are deployed; a deployment area wherein one or more network nodes and/or radio cells are deployed; and/or a relation between a group of network nodes and/or between a group of radio cells.

5. The method according to claim 1, wherein determining information for configuring the at least one network functionality is further based on a second AI/ML model, wherein input to the second AI/ML model includes one or more of:
i. the encoding reconstructing the environment where the at least one network functionality to be configured is operating;
ii. the second set of network state information for environment reconstruction; and/or
iii. a representation of at least one metric associated with the at least one network functionality to be optimized; and
the method further comprising executing the second AI/ML model, wherein the output of executing the second AI/ML model includes the information for configuring the at least one network functionality.

6. The method according to claim 5, wherein the second set of network state information includes dynamically changing information characterizing one or more of: a state associated to the network functionality to be configured; information associated to a state of network nodes, radio cells or user devices involved with the network functionality;
measurements or predictions of signal strength or signal quality; measurements or predictions or cell load information and/or cell capacity information; measurements or predictions of energy consumption or an energy saving mode for user devices, radio cells or network nodes;
observable dynamics of the at least one network functionality to be configured, information associated to the state of the first network node, and/or to the state of at least a second network node, and/or to the state of at least a user device; information associated to the state dynamics of at least a functionality a network node or a radio cell; and/or information associated to the state dynamics of at least a functionality a user device.

7. The method according to claim 1, wherein the first AI/ML model is designed such that the encoding reconstructing the network environment is associated to one of the first network node, a serving cell of the first network node, or a user device served by at least a serving cell of the first network node.

8. The method according to claim 1, wherein the at least one network functionality includes one or more of: network functionalities operating at different levels of the RAN protocol stack including from physical layer (PHY) to medium access control (MAC) layer, routing, transport, application layer, network configuration and deployment and core network operations; PHY layer functionalities, channel estimation, signal demodulation, and decoding; MAC layer functionalities, link adaptation, radio resource allocation, user scheduling over time and frequency resources, power control, and precoding;
and/or functionalities acting on network configuration, mobility optimization, mobility load balancing, capacity and coverage optimization, energy saving configurations, cell shaping, network hyperparameters configuration, antenna tilt, control channel resources, semi-static uplink power control parameters, TTD configuration, FDD configuration, discontinuous transmission DTX configuration, discontinuous reception DRX configurations, configuration of downlink reference signals, and network slicing such as configuration of network slices and allocation of radio resources to network slices or subscribers thereof.

9. The method according to claim 1, wherein the first set of network state information and/or the encoding reconstructing the environment includes one of: network-node-centric state information and/or environment reconstruction; cell-centric state information and/or environment reconstruction; or user-centric state information and/or environment reconstruction.

10. The method according to claim 1, wherein the first set of network state information is represented in the form of a graph constructed as one of: a network-centric graph, a cell-centric graph, or a user-centric graph.

11. The method according to claim 1, wherein the communication network environment includes one or more of: a radio access network (RAN) environment and/or an open radio access network (O-RAN) environment.

12. The method according to claim 1, wherein the first network node is one of: a RAN node, an OAM, a Core Network node, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, or a UE.

13. The method according to claim 1, wherein the first network node is configured as one of: a physical node, a function, or a logical entity.

14. The method according to claim 1, wherein the first network node is configured as a logical entity and the logical entity is:
configured as a software entity;
implemented in one of a data center or a cloud; or
implemented using one or more virtual machines.

15. The method according to claim 1, further comprising:
receiving, at the first network node, information characterizing a set of network nodes and/or radio cells surrounding a reference network node or radio cell that are related to and/or have an effect on the performance of the reference network node or radio cell.

16. The method according to claim 1, wherein the representation of at least one metric associated with the at least one network functionality to be configured includes at least one metric associated to one of: a user device, a radio cell, or at least a network node.

17. (canceled)

18. A computer-implemented method executed by a first network node in a communication network environment, for generalizing design of at least one artificial intelligence/machine learning (AI/ML) model for configuring at least one network functionality in the environment, comprising:
obtaining a first set of network state information for reconstructing the environment to configure the at least one network functionality;
determining, based on a first AI/ML model, an encoding reconstructing the environment where the at least one network functionality to be configured is operating, wherein input to the first AI/ML model includes the first set of network state information;
executing the first AI/ML model, wherein the output of executing the first AI/ML model includes the encoding reconstructing the environment;
obtaining a second set of network state information for reconstructing the environment to configure the at least one network functionality;
determining information for configuring the at least one network functionality based on one or more of:
i. the encoding reconstructing the environment where the at least one network functionality to be configured is operating;
ii. the first set of network state information for environment reconstruction;
iii. the second set of network state information for environment reconstruction; and/or
iv. a representation of at least one metric associated with the at least one network functionality to be optimized; and
-configuring, based on the information, the at least one network functionality.

19. A computer-implemented method executed by a first network node in a communication network environment, for generalizing design of at least one artificial intelligence/machine learning (AI/ML) model for configuring at least one network functionality in the environment, comprising:
obtaining a first set of network state information for reconstructing the environment to configure the at least one network functionality;
obtaining a second set of network state information for reconstructing the environment to configure the at least one network functionality;
executing a third AI/ML model, wherein input to the third AI/ML model includes one or more of:
i. the first set of network state information for environment reconstruction;
ii. the second set of network state information for environment reconstruction;
and/or iii. a representation of at least one metric associated with the at least one network functionality to be configured;
determining, based on the output of executing the third AI/ML model, information for configuring the at least one network functionality; and
configuring, based on the information, the at least one network functionality.

20.-38. (canceled)

39. A node in a communication network environment, for generalizing design of at least one artificial intelligence/machine learning (AI/ML) model for configuring at least one network functionality in the environment, the node comprising:
one or more memories comprising instruction data representing a set of instructions; and
one or more processors configured to communicate with the one or more memories and to execute the set of instructions, wherein the set of instructions, when executed by the one or more processors, cause the one or more processors to
obtain a first set of network state information for reconstructing the environment to configure the at least one network functionality;
determine, based on a first AI/ML model, an encoding reconstructing the environment where the at least one network functionality to be configured is operating, wherein input to the first AI/ML model includes the first set of network state information;
execute the first AI/ML model, wherein the output of executing the first AI/ML model includes the encoding reconstructing the environment;
obtain a second set of network state information for reconstructing the environment to configure the at least one network functionality;
determine information for configuring the at least one network functionality based on one or more of:
i. the encoding reconstructing the environment where the at least one network functionality to be configured is operating;
ii. the second set of network state information for environment reconstruction; and/or
iii. a representation of at least one metric associated with the at least one network functionality to be optimized; and
configure, based on the information, the at least one network functionality.

40. A computer program product comprising a non-transitory computer readable medium storing instructions which, when executed by processing circuitry, causes the processing circuitry to carry out the method of claim 1.

41.-43. (canceled)
